(19) United States
(12) Patent Application Publication
(10) Pub. No.: US 2016/0342846 A1
(43) Pub. Date: Nov. 24, 2016

(54) Systems, Methods, and Devices for Information Sharing and Matching

(71) Applicant: Facewatch Limited, Ipswich (GB)

(72) Inventors: Simon Gordon, Ipswich (GB); Andrew Wood, Ipswich (GB)

(73) Assignee: FACEWATCH LIMITED, Ipswich (GB)

(21) Appl. No.: 14/718,825

(22) Filed: May 21, 2015

(51) Int. Cl. G06K 9/00; G06K 9/52; G06K 9/46; G06K 9/62

(52) U.S. Cl. CPC G06K 9/00771; G06K 9/6201; G06K 9/52; G06K 9/46; G06K 9/00288; G06K 2009/4666; G06K 2009/00738

(57) ABSTRACT

The present invention relates to systems, methods, and devices for correlating and sharing information. In particular, the invention relates to systems, methods, and devices for identifying subjects of interest suspected of involvement in one or more crimes, and sharing and correlating information relating to subjects and events. In further aspects of the invention, methods and system are provided for sharing alerts between users of electronic devices.

### 1. TECHNICAL FIELD

The present invention relates to systems, methods, and devices for correlating and sharing information. In particular, the invention relates to systems, methods, and devices for identifying subjects of interest suspected of involvement in one or more crimes, and sharing and correlating information relating to subjects and events.

### 2. BACKGROUND

Often, when an incident occurs, for example a crime is committed, the incident, any people suspected of involvement with the incident, and any vehicles suspected of involvement with the incident are captured on closed circuit television (CCTV) or similar surveillance systems. When the same person or vehicle is involved in a different incident caught on the CCTV at a different time or in different geographical location, it can be difficult to identify the person or vehicle as the same. Further, due to the large quantity of incidents and high workloads, it is often difficult for law enforcement to identify the suspect or vehicle and to bring appropriate charges.

There exists a need for systems, methods, and devices to enable the sharing and correlating of information relating to people suspected of involvement in incidents and of the incidents themselves in an easily-accessible and efficient manner.

### 3. SUMMARY OF THE INVENTION

In a first aspect of the invention, a computer-implemented method is provided, the method comprising receiving subject data objects from a first electronic device; receiving event data objects from a second electronic device; associating each subject data object with a single event data object; associating each event data object with one or more of the subject data objects; generating unmatched subject data objects comprising for each subject data object at least a portion of the each subject data object and at least a portion of the single event data object associated with the subject data object; and sending, to a third electronic device, the unmatched subject data objects for display at the third electronic device.

The method of claim may further comprise receiving, from the third electronic device, match data comprising indications of two or more unmatched subject data objects; and associating the each unmatched subject data object contained in the match data with each of the other unmatched subject data objects contained in the match data.

The method may also further comprise, prior to receiving match data, receiving, from the third electronic device, a selection pertaining to a first unmatched subject data object; determining whether at least one second subject data object sufficiently matches the first subject data object corresponding to the first unmatched subject data object; generating at least one second unmatched subject data object comprising for each of the at least one second subject data objects at least a portion of the at least one second subject data object and at least a portion of the single event data object associated with the second subject data object; and sending, to the third electronic device, the first unmatched subject data object and the at least one second unmatched subject data object for display at the third electronic device.

Preferably, the match data further comprises an indication of the first unmatched subject data object.

Also preferably, the step of determining comprises filtering subject data objects that are associated with event data objects other than the event data object associated with the first unmatched subject data object; and the at least one second subject data object is selected from the filtered subject data objects and has one or more elements of subject data in common with the first subject data object associated with the first unmatched subject data object.

The subject data objects may comprise at least one image, and the step of determining may further comprise performing an image matching process to generate, for each of the second subject data objects other than the first subject data object associated with the first unmatched subject data object, a match rating which represents a likelihood that an image object in the image associated with the second subject data object is the same as an image object in image associated with the first subject data object, wherein second unmatched subject data objects are generated for second subject data objects with a match rating greater than a threshold.

Preferably, the at least one second unmatched subject data object comprises two or more second unmatched subject data objects, and the second unmatched data objects are sorted into a display order, which forms part of each second unmatched subject data object.

The display order of second unmatched subject data objects may be sorted according to the match rating.

Event data objects may comprise location data corresponding to the location of the event, and the display order of second unmatched subject data objects may be sorted according to a geographical distance between the location associated with the first event data object associated with the first unmatched subject data object and the location associated with the second event data object associated with each second unmatched subject data object.

The first, second and third electronic devices may be the same electronic device; or the first, second and third electronic devices may be different electronic devices; or the first and second electronic devices may be the same electronic device which is different to the third electronic device; or the first and third electronic devices may be the same the same electronic device which is different to the second electronic device; or the second and third electronic devices may be the same electronic device which is different to the first electronic device.

Preferably, each subject data object corresponds to a person, vehicle, or other entity suspected of involvement in a crime. The subject data may comprise one or more images. The one or more images may depict the person, vehicle, or other entity suspected of involvement in a crime. The one or more images may additionally or alternatively be images captured by premises at which the event occurred.

Also preferably, each event data object corresponds to a crime that has been committed, or other event data object that has occurred.

Preferably, the match data corresponds to one or more subject data objects each associated with one of the one or more unmatched subject data objects that relate to the same suspect.

In a second aspect of the present invention a computer-implemented method is provided. The method comprises receiving, from a first electronic device, one or more first unmatched subject data objects; outputting, on a display, the one or more first unmatched subject data objects; receiving input pertaining to the one or more selected first unmatched subject data objects selected from the first unmatched subject data objects; sending, to the first electronic device, an indication of the one or more selected first unmatched subject data objects, wherein each unmatched subject data object comprises at least a portion of a subject data object and at least a portion of a single event data object associated with the subject data object, wherein each subject data object is associated with a single event data object; and wherein each event data object is associated with one or more of the subject data objects.

The input pertaining to one or more selected first unmatched subject data objects may pertain to two or more selected first unmatched subject data objects, and the indication of the two or more selected first unmatched subject data objects may form match data.

The input pertaining to one or more selected first unmatched subject data objects may pertain to one selected first unmatched subject data object, and the method may further comprise, following sending the selected first unmatched subject data object, receiving, from the first electronic device, one or more second unmatched subject data objects and the selected first unmatched subject data object; outputting, on the display, the selected first unmatched subject data object and the one or more second unmatched subject data objects; receiving input pertaining to one or more selected second unmatched subject data objects selected from the second unmatched subject data objects; sending, to the first electronic device, match data comprising an indication of the one or more selected second unmatched subject data objects.

The match data may further comprise an indication of the selected first unmatched subject data object.

Preferably, the second step of outputting on the display comprises outputting the one or more second unmatched subject data objects in a display order.

The display order may be received from the first electronic device at the step of receiving the one or more second unmatched subject data objects.

The step of receiving input may comprise receiving a tap and/or gesture from a touch-sensitive display, or receiving a click from a computer mouse, or receiving a key press from a computer keyboard.

The step of outputting may comprise rendering a web page in a web browser.

In a third aspect of the invention, a graphical user interface is provided which comprises a first display item corresponding to a first unmatched subject data object, and one or more second display items, each second display item corresponding to a second unmatched subject data object; wherein the first display items comprises at least one image associated with the first unmatched subject data object and the one or more second display items each comprise at least one image associated with the corresponding second unmatched subject data object; wherein each of the one or more second display items is selectable by a user via the graphical user interface, and wherein upon selection of one or more second display items, the graphical user interface is configured to provide an instruction to a database manager to create an association between the second unmatched subject data objects corresponding to the one or more selected second display items and the first unmatched subject data object.

Preferably, the first unmatched subject data object and one or more second unmatched data objects are associated with event data objects, wherein the event data objects comprise one or more of location data corresponding to the location of the event and date or time data at which the event occurred.

The graphical user interface may be configured to sort the one or more second display items according to a geographical distance between the location associated with the first event data object associated with the first unmatched subject data object and the location associated with the second event data object associated with each second unmatched subject data object.

The graphical user interface may be configured to sort the one or more second display items according to the date or time data associated with the second event data object associated with each second unmatched subject data object.

The graphical user interface may further comprise a filtering control object that allows a user to filter the second display objects according to one or more attributes of the second unmatched subject data object and/or event data object associated with the second unmatched subject data object associated with each second display object.

The graphical user interface of may further comprising a sorting control object that allows a user to sort the second display objects according to one or more attributes of the second unmatched subject data object and/or event data object associated with the second unmatched subject data object associated with each second display object.

In a fourth aspect of the invention, a system is provided. The system comprises the graphical user interface discussed above.

The system of may further comprise a facial recognition system, and the graphical user interface may be configured to sort the one or more second display items according to a match rating provided by a facial recognition subsystem.

Preferably, the graphical user interface is configured to display only second display items with a match rating higher than a pre-determined threshold.

In a fifth aspect of the invention, a computer-implemented method is provided. The method comprises receiving, on an electronic device, location data, text data, and one or more of: audio data, video data and image data; generating an alert data object comprising the location data, text data, and one or more of audio data, video data and image data, and further comprising user account data associated with a user of the electronic device; transmitting, to a second electronic device, the alert data object.

The method may further comprise the steps receiving, at the second electronic device, the alert data object; retrieving, by the second electronic device, one or more target user accounts associated with the user account contained in the alert data object from a memory communicatively coupled to the second electronic device; and transmitting the alert data object from the second electronic device to one or more target electronic devices associated with the target user accounts.

The alert data object generated by the first electronic device may also comprise a group ID identifying a plurality of target user accounts, and the step of retrieving may comprise retrieving, from the memory associated with the second electronic device, the target user accounts associated with the group ID.

Alternatively, the step of retrieving may further comprise retrieving a group ID identifying a plurality of target user accounts from the memory communicatively coupled to the second electronic device based on the user account contained in the alert data object; and retrieving, from the memory communicatively coupled to the second electronic device, the target user accounts associated with the group ID.

The step of generating may further comprise including in the alert data object a telephone number associated with the first electronic device.

Preferably, the location data is a location of the device as measured by one of: GPS, A-GPS, WPS or any other positioning system.

Also preferably, the location of the first device is displayed on a map prior to generating and/or transmitting the alert data object.

In a sixth aspect of the invention, a computer-implemented method is provided, the method comprising receiving, by an electronic device, an alert data object, the alert data object comprising text data, location data and data pertaining to one or more of: image data, video data, and audio data; generating an alert display object corresponding to the alert data object; and outputting, on a display associated with the electronic device, the alert display object, wherein text data is displayed on the display simultaneously with the location data and one or more control objects that cause the one or more of image data, video data and audio data to be accessed when selected.

Preferably, the location data is displayed on a map.

The alert data object may further comprise a telephone number associated with a second electronic device, and wherein a control object configured to establish a telephone call using the telephone number associated with the second electronic device is displayed simultaneously with the location data and text data.

The data pertaining to video data, image data, or audio data may be a link to a network location, and wherein the control objects are configured to retrieve from the network location when selected.

In a seventh aspect of the invention, a computer-implemented method is provided, the method comprising receiving, at a first electronic device, text data and alert time data from a second electronic device; generating an alert data object, wherein the alert data object comprises the text data and alert time data; storing, in a memory of the first electronic device, the alert data object; receiving, from a third electronic device, a request for alert data objects; transmitting, to the third electronic device, the alert data object; and wherein the alert time data defines a time period the alert data object should be displayed on a display connected to the third electronic device.

The step of receiving may include receiving alert creation time data, wherein the alert creation time data is the time at which the data is transmitted to the first electronic device.

The step of generating may include calculating alert expiry time data by adding the alert time data to the alert creation time data, wherein the alert expiry time data defines a time after which the alert data object should no longer be displayed on a display connected to the third electronic device.

At the step of receiving, the alert time data may be alert expiry time data which defines a time after which the alert display object, and wherein the alert expiry time data is included in the generated alert display, wherein the alert expiry time data defines a time after which the alert data object should no longer be displayed on a display connected to the third electronic device.

The step of receiving may include receiving alert priority data, and the alert priority data may be included in the generated alert data object.

Alternatively, the alert time data may define a time period for which the alert data object is to be stored in the memory.

The step of transmitting may include retrieving from the memory any alert data objects and transmitting all retrieved alert data objects to the third electronic device.

The alert time data may define a time period for which the alert data object is to be flagged as active in the memory, and only alert data objects flagged as active may be retrieved from the memory and transmitted to the third electronic device.

The data received from the second electronic device may include a group ID, the request may include user account data associated with the third electronic device, the generated alert data object includes the group ID and wherein the step of transmitting includes retrieving a group ID associated with the user account data from a memory associated with the first electronic device and transmitting only those alert data objects stored in memory which have a corresponding group ID.

Alternatively, the data received from the second electronic device may include first user account data associated with the second electronic device, the request may include second user account data associated with the third electronic device, the step of generating may include retrieving a group ID associated with the user account data from a memory associated with the first electronic device, the generated alert data object may include the group ID and the step of transmitting may include retrieving a group ID associated the second user account data from a memory associated with the first electronic device and transmitting only those alert data objects stored in memory which have a corresponding group ID.

Further alternatively, the data received from the second electronic device may include a first group ID, the request may include a second group ID associated with the third electronic device, the generated alert data object may include the first group ID and the step of transmitting may comprise transmitting only those alert data objects stored in memory which have a the second group ID.

In an eighth aspect of the invention, an electronic device is provided which comprises processing circuitry configured to perform the steps of any of the above methods.

In a ninth aspect of the invention, a computer-readable medium is provided which comprises computer executable instructions executable by processing circuitry, which, when executed, cause the processing circuitry to perform the steps of any one of the above methods.

### 4. BRIEF DESCRIPTION OF THE DRAWINGS

FIG. 1 depicts a system that may be used to implement embodiments of the present invention.

FIG. 2 depicts an example user interface that may be used to input information relating to an incident.

FIG. 3 depicts an example user interface that may be used to input information relating to a subject of interest associated with an incident.

FIG. 4 depicts relationships which may be present between subject data objects and event data objects.

FIG. 5 depicts an example user interface layout of a watch list for displaying subject data objects.

FIG. 6 depicts an alternative example user interface for displaying subject data objects.

FIG. 7 depicts a further example user interface for displaying a selected subject data object.

FIG. 8 depicts a further example user interface for inputting information related to a selected subject data object.

FIG. 9 depicts a method of matching a first unmatched subject data object with other unmatched subject data objects.

FIG. 10 depicts an example match view user interface layout.

FIG. 11 depicts a flow diagram showing an alternative method for matching unmatched subject data objects.

FIG. 12 depicts an arrangement of subject data objects between which permissions to perform and view the results of a facial recognition system may be restricted.

FIG. 13 depicts an example user interface for creating and transmitting an alert.

FIG. 14 depicts an example user interface for viewing an alert.

FIG. 15 depicts a flow diagram of a method for generating and transmitting alert data objects in correspondence with the user interface of FIG. 13.

FIG. 16 depicts a flow diagram of a method for receiving and displaying the alert data objects generated in method 1500, and in accordance with the user interface depicted in FIG. 14.

FIG. 17 depicts a further example user interface for creating an alert.

FIG. 18 depicts a further example user interface in which an alert is displayed.

FIG. 19 depicts a flow diagram showing a method for generating alerts and transmitting the generated alerts to one or more electronic devices corresponding to the user interfaces described with respect to FIGS. 17 and 18.

### 5. DETAILED DESCRIPTION

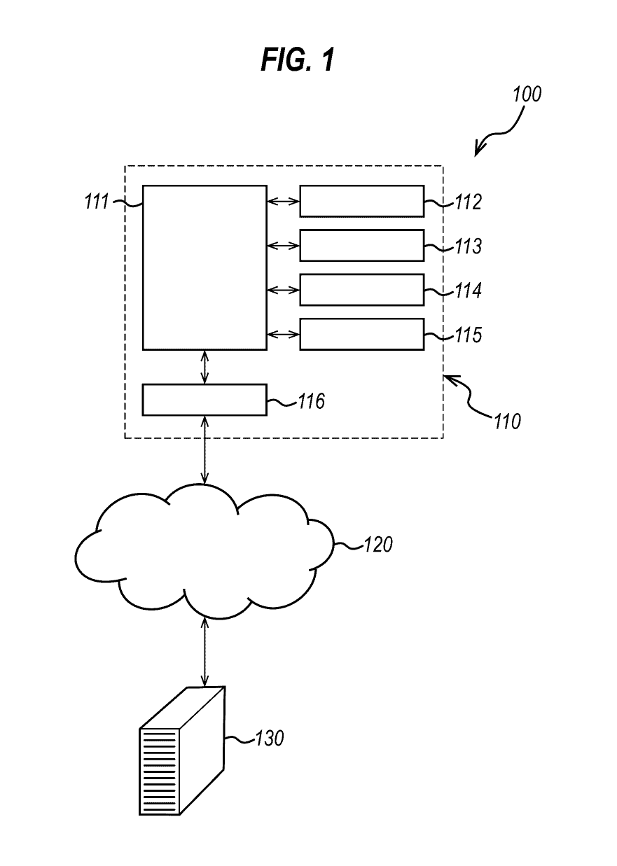

FIG. 1 depicts a system 100 that may be used to implement embodiments of the present invention. System 100 comprises an electronic device 110, a network 120, and a server 130.

Electronic device 110 comprises a processor 111 communicatively coupled with a volatile memory 112, non-volatile memory 113, one or more display devices 114, one or more human interface devices 115, and one or more network interfaces 116. The one or more human interface devices (HID) 115 may comprise one or more of: a keyboard, mouse, trackball, track pad, touchscreen, physical buttons, or any other known human interface device. The one or more network interfaces 116 may comprise one or more of: a Wi-Fi interface configured to use a network employing one of the 802.11 family of standards; a cellular data adapter configured to use cellular data networks such as LTE, HSPA, GSM, UTMS, or any other known cellular data standard; a short-distance wireless interface configured to use Bluetooth or any other known short-range wireless standard; a wired network interface configured to use Ethernet or any other known wired network standard.

Electronic device 110 may run an operating system within which a web browser application may run and be configured to send and receive HTTP requests and responses and display web pages of a website using one or more of: HTML, JavaScript, XML, JSON, Adobe Flash, Microsoft Silverlight, or any other known browser-based language or software. Alternatively or additionally, electronic device 110 may run a dedicated application configured to send and receive data from server 130 and configured to display data received from server 130 in a pre-determined manner.

Network interface 116 is communicatively coupled with network 120. Network 120 may be a wide area network, for example the Internet, or a local area network. Network 120 is also communicatively coupled with server 130. Server 130 may be a dedicated server, or any other computer system capable of network access that is configured to receive requests and provide responses over network 120. In this manner, electronic device 110 and server 130 may communicate via network 120. Server 130 may communicate using a communication protocol such as TCP/IP, or any other known communication protocol. Server 130 may run a web server which is configured to receive HTTP requests and provide HTTP responses.

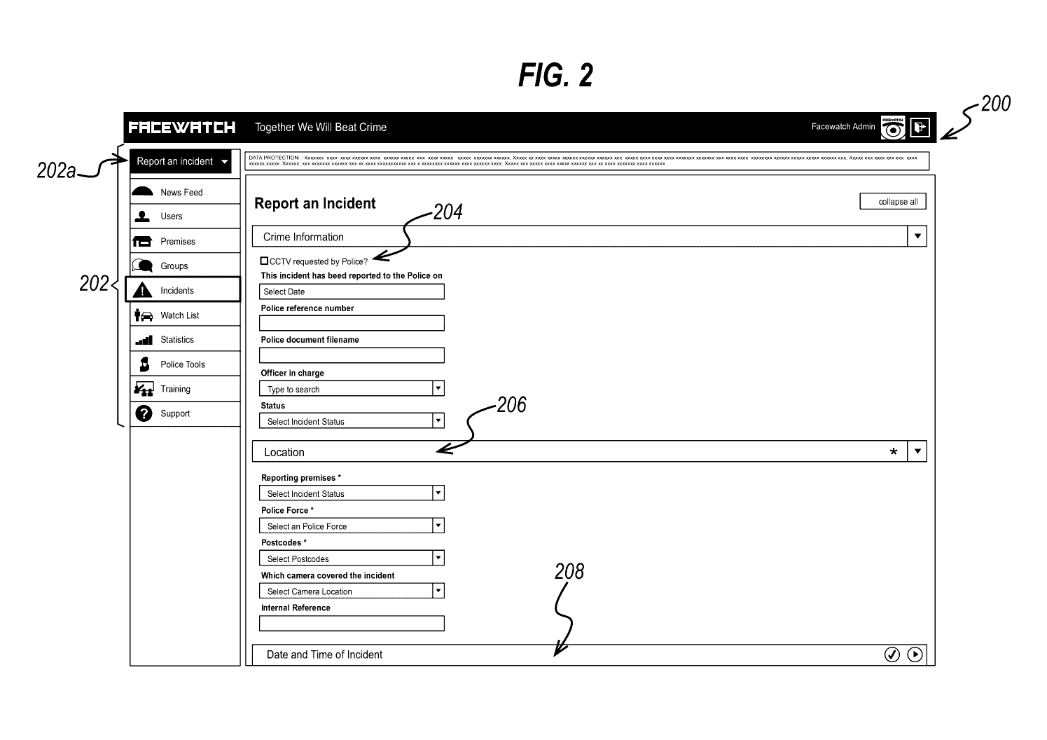

FIG. 2 depicts an example user interface 200 of the aforementioned website or dedicated application that may be used to input information relating to an incident.

User interface 200 may be provided by a web app, running on server 130, accessed via a web-browser on electronic device 110. Alternatively, user interface 200 may be provided by a dedicated application which runs on electronic device 110. The user interface 200 may be displayed following the selection of an option provided in menu 202, such as the ‘Report an Incident’ button 202a.

The user interface 200 is used to report an incident. An incident may be a crime, a disturbance, or some other event of which the user of the system would like to make a record. The incident may have several attributes associated with it, such as crime information, which may be input in the fields in panel 204; location information, which may be input in panel 206; and date and time information, which may be input in panel 208. Each of the fields in panels 204-208 may be one or more of check boxes, radio buttons, dropdown boxes, text fields, text areas, buttons, file upload forms or any other common user interface objects. It will be appreciated that the specific arrangement of field and controls within panels and within the user interlace is not an essential feature of the invention, and is merely provided for illustrative purposes.

User interface 200 may further include additional user interface elements, such as panels and fields, which enable a user to input additional attributes related to the incident such as an incident type, items involved in the incident, a description of the incident, CCTV images or video related to the incident, and subjects of interest associated with the incident.

When the details of an incident have been entered into the user interface 200, the user may select a button such as a ‘submit report’ button, which causes the web application to save the information that has been input as an event data object. Each event data object may be stored in a database, such as a relational database, a NoSQL database, a graphing database, or any other known type of database.

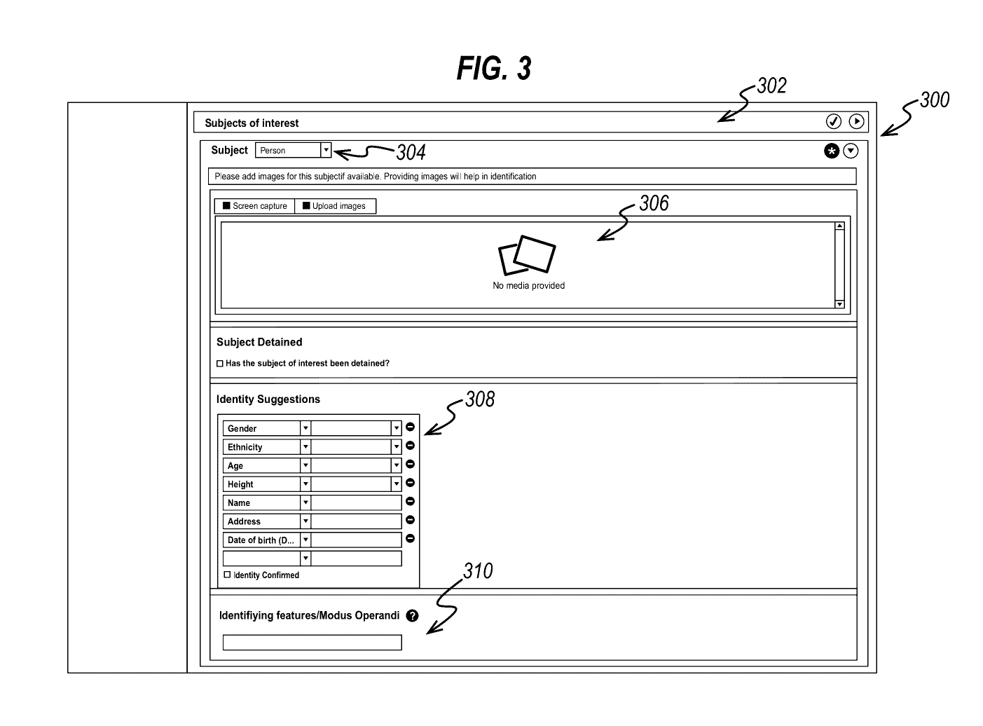

FIG. 3 depicts a further view of user interface 200, depicting user interface panels and field which may be used to input information relating to a subject of interest associated with an incident.

As discussed above, user interface 200 may further provide user interface elements which enable a user to input information about a subject of interest associated with the incident which is to be reported. Panel 302 is an example of such a user interface element. A drop box 304 is provided which enables selection of the type of subject of interest from a list, for example: person, vehicle, or other. Upload form 306 enables a user to upload images related to the subject of interest. For example, if the subject of interest is a person suspected of involvement in a theft from a bar, CCTV images of the subject captured on the bar's CCTV system may be uploaded. A further option may be provided to upload a screen capture. Fields 308 allow a user to input identifying information about the subject, such as gender, ethnicity, age, height, name, address or date of birth. It will be appreciated that any other information which may be used to identify the subject of interest may be provided in fields 308. Additionally, further fields 310 are provided which enable specific identifying features or a modus operandi of the subject to be input. Other information regarding the subject of interest may also be provided via user interface 200, such as postcodes, districts or areas in which the subject of interest is known to be active or otherwise associated with. User interface 200 may also comprise an option to provide information regarding more than one subject of interest. Again, it will be appreciated that the specific arrangement of user interface elements depicted is not essential to the definition of the invention and is provided as an example.

When the details relating to the incident and the one or more subjects of interest have been input, the user may select a button such as a ‘submit report’ button, which causes the web application to save the information that has been input. As discussed above, the information related to the incident is saved in an event data objects in a database. The information related to the one or more subjects of interest is stored in one or more subject data objects that are associated with the event data objects.

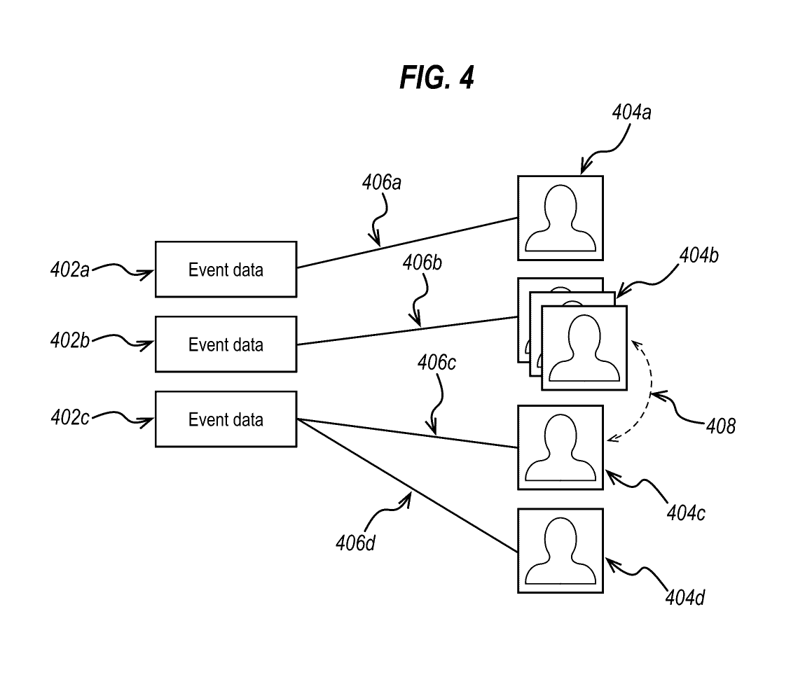

FIG. 4 depicts relationships between subject data objects and event data objects in an embodiment of the present invention.

As discussed above, each subject data object comprises identifying data which relates to a person, vehicle, or other entity; the actual person, vehicle, or other entity that the subject data object relates to is referred to as the ‘subject of interest’. For example, a subject data object may comprise identifying data relating to features of the suspect such as gender, race, height, age, hair colour, build, or any other physically identifying data. A subject data object may further comprise an image of the suspect.

Each subject data object is associated with an event data object. As discussed above, an event data object may correspond to a crime, such as a theft, burglary, or assault, or a disturbance; however, it will be appreciated that event data objects are not limited to a crime as defined in the law of any particular jurisdiction, and may comprise any type event data object that has occurred in relation to a suspect and subject data object.

The present invention relates to systems and methods used to identify the subjects of interest related to subject data objects, or to match the subjects of interest that relate to subject data objects that are associated with different event data objects.

Each event data object is associated with one or more subject data objects; however, each subject data object is directly associated with only one event data object. This arrangement between subject data objects and event data objects is depicted in FIG. 4.

Three event data objects 402a-c are shown, although it will be appreciated that any number of event data objects greater than or equal to one may be used. Each event data object 402a-c is associated with one or more subject data objects 404a-d. The associations 406a-d between event data objects and subject data objects may be created when the event data is entered to the system, or at a later time. Each subject data object may comprise one or more images. For example, subject data object 404b is depicted as comprising three images. The images may depict the subject of interest to whom or which the subject data object relates.

As mentioned above, each event data object 402a-c may be associated with one or more subject data objects. However, each subject data object may only be associated with one event data object 402a-c. This is demonstrated in FIG. 2, where event data objects 402a and 402b are each associated with one subject data object (404a and 404b respectively), and event data object 402c is associated with two subject data objects, 404c and 404d.

Following a matching process, which is described in detail below, a subject data object may be linked with one or more other subject data objects, depicted in FIG. 4 by subject data objects 404b and 404c and the link 408.

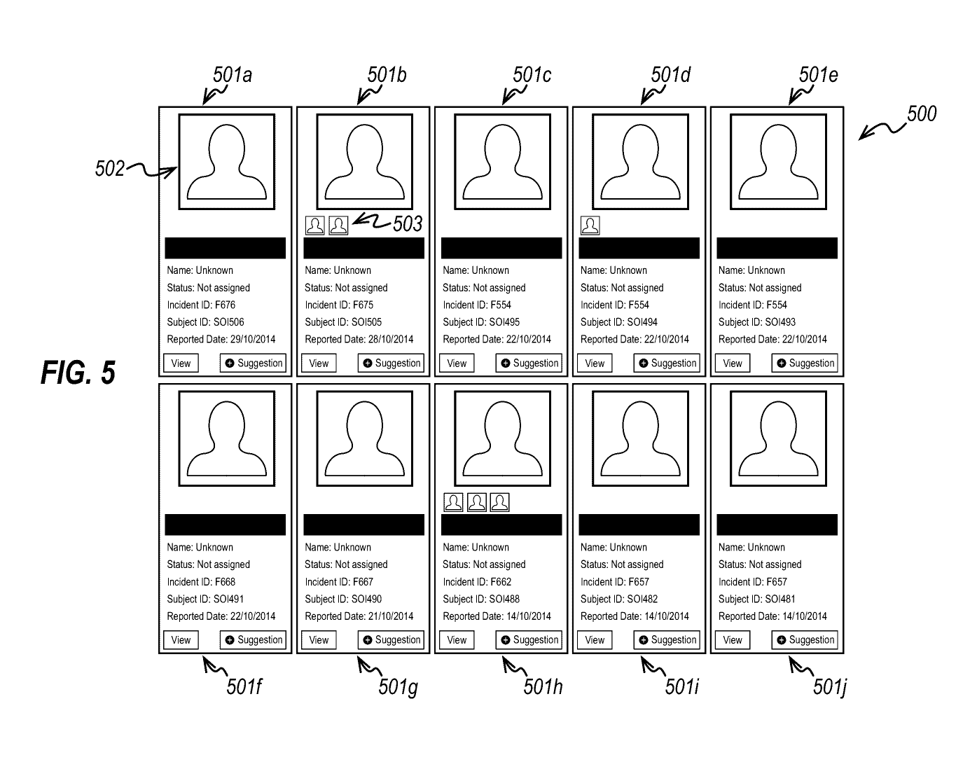

FIG. 5 depicts an example user interface layout of a watch list 500 that may form part of the present invention, though it will be appreciated that the watch list may be displayed in different layouts to that depicted. The watch list 500 may be displayed on display device 114, and the user interface layout may be generated by the processor 111, or may be generated by server 150 and displayed in a web browser or dedicated application on display device 114.

The watch list 500 may comprise one or more display objects 501a-j which correspond to subject data objects 501a-j. Each of the display objects 501a-j may have one or more associated images 502, 503. The images 502, 503 may depict the suspect to whom or which the relevant subject data object relates. These images 502, 403 may be images retrieved from CCTV or other surveillance means, police photographs of suspects, or images acquired by other means.

For any given device, display objects 501a-j may be displayed in a particular order in the watch list. The order in which the display objects 501a-j are displayed in the watch list 500 maybe be sorted according to one or more of: a date of the incident pertaining to the event data object associated with each corresponding subject data object; a time at which the incident pertaining to the event data object associated with each corresponding subject data object took place; the distance between a location at which the incident pertaining to the event data object associated with each corresponding subject data object took place and a location of the device; and the distance between a location at which the incident pertaining to the event data object associated with each corresponding subject data object took place and a location associated with a user account.

A display object 501a-j may be selected from the watch list, causing the display of further information associated with the corresponding subject data object and/or further information associated with the event data object with which the corresponding subject data object is associated.

This further information associated with the subject data object may include the identifying data, which forms part of the subject data object. As discussed above, the identifying data within a subject data object may further comprise one or more of: a name of the subject, an address of the subject, the date of birth of the subject, an alias of the subject, or any other information that may aid in the identification of the suspect.

Each subject data object may be associated with an event data object. The event data or event data object may include: an event ID, a date on which the event took place, a location at which the event took place, a police force/law enforcement agency whose jurisdiction the event falls within, an event type, a date on which the event was reported to the police/law enforcement, a police/law enforcement reference, a police/law enforcement filename, a police/law enforcement officer in charge, comments, a witness statement, CCTV images, victim details, objects associated with the event.

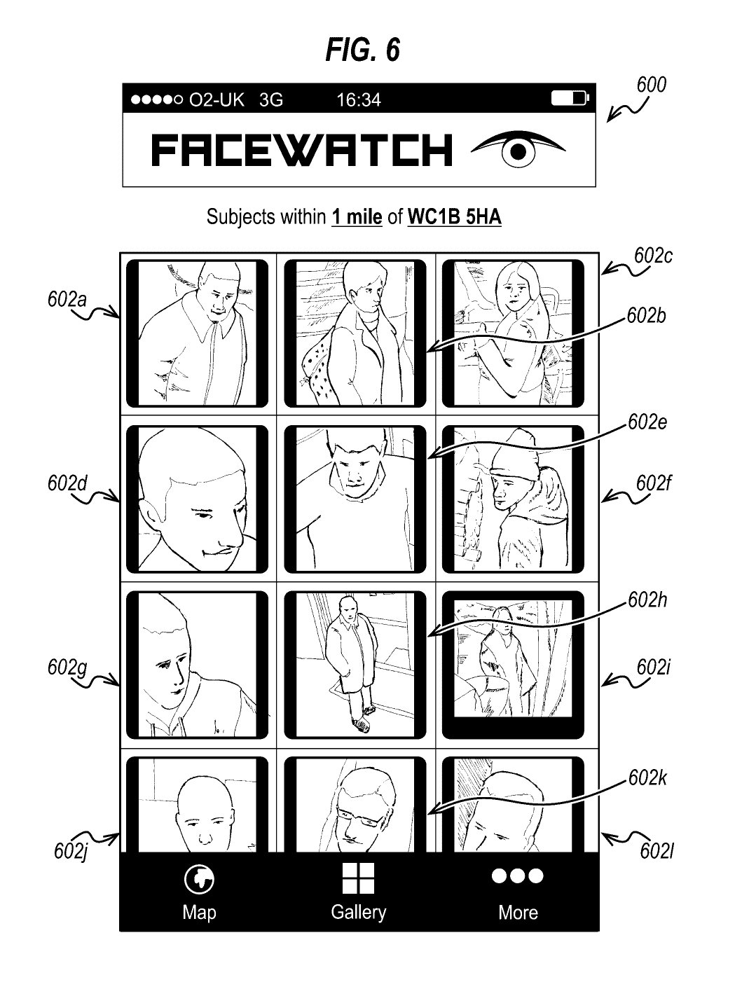

FIG. 6 depicts an alternative user interface 600 for presenting display objects relating to subject data objects. The user interface 600 may be provided instead of or in addition to the watch list 500. For example, the watch list 500 may be provided in a web browser accessed by a desktop or laptop computer and the user interface 600 may be provided on a mobile device such as a mobile phone or tablet.

User interface 600 comprises one or more display objects 602a-1 which relate to subject data objects. Each display object 602a-1 comprises an image of the subject of interest that is associated with the subject data object. The display objects 602a-1 that are depicted in FIG. 6 may be a subset of a larger number display objects that relate to subject data objects, for example when not all of the display objects can be displayed at one time due to screen area limitations. Furthermore, the display objects 602a-1 may relate only to a subset of subject data objects from the set of all subject data objects stored by the system. For example, only subject data objects that are associated with an event data object with a location within a given distance of the user may be displayed. The filter used to determine which subset of the subject data objects are represented by display objects in the user interface 600 may be based on any of the attributes or information associated with the subject data objects.

Display objects 602a-1 may be displayed in a particular order in the user interface 600. The order in which the display objects 602a-1 are displayed may be sorted according to one or more of: a date of the incident pertaining to the event data object associated with each corresponding subject data object; a time at which the incident pertaining to the event data object associated with each corresponding subject data object took place; the distance between a location at which the incident pertaining to the event data object associated with each corresponding subject data object took place and a location of the device; and the distance between a location at which the incident pertaining to the event data object associated with each corresponding subject data object took place and a location associated with a user account.

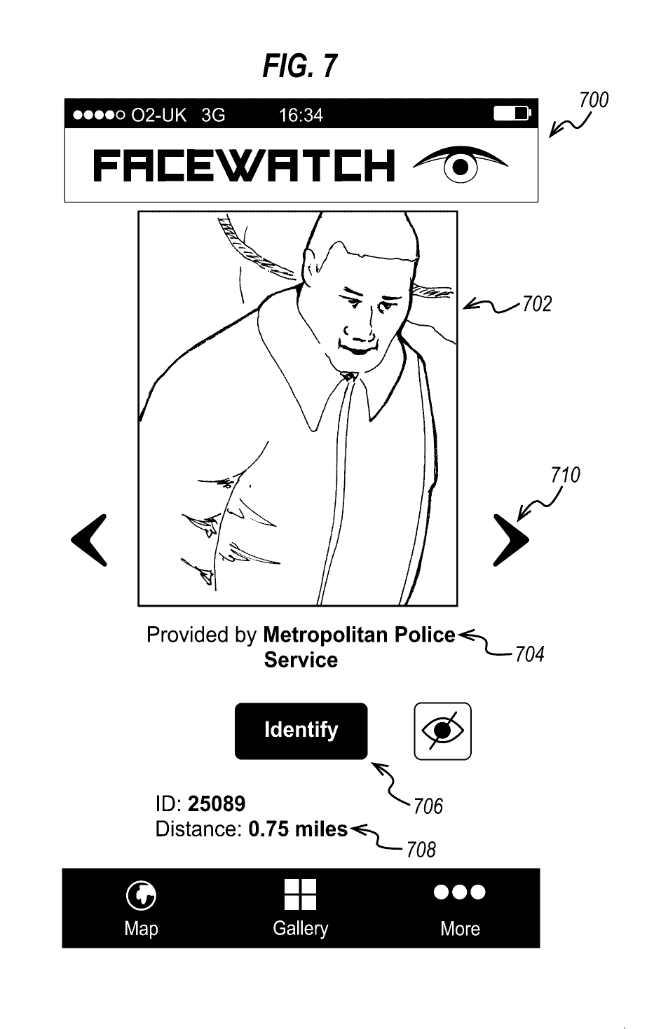

Each display object 602a-1 may be selectable, for example by clicking a mouse cursor anywhere within the boundary of a display object 602a-1 or by tapping a touch screen anywhere within the boundary of the display object 602a-l. Selection of one of the display objects 602a-1 causes a second user interface 700, depicted in FIG. 7, to be displayed.

The user interface 700, depicted in FIG. 7, provides a more detailed view of the subject data object corresponding to the selected display object, selected from user interface 600. The user interface 700 comprises one or more images 702 associated with the subject data object, further information 704, 708 related to the subject data object, such as who provided the data that forms the subject data objects, a distance from the location of the user of the user interface that forms event data associated with the subject data object. A control object, such as button 706, may also be provided which, on selection, causes a third user interface 800, depicted in Figure C to be displayed. Further control objects 710 may be provided in user interface 700, which, on selection, cause further information relating to a different subject data object to be displayed. For example, selecting the arrow 710 may cause further information for the next subject in the display order of display items 602a-1 in user interface 600 to be displayed.

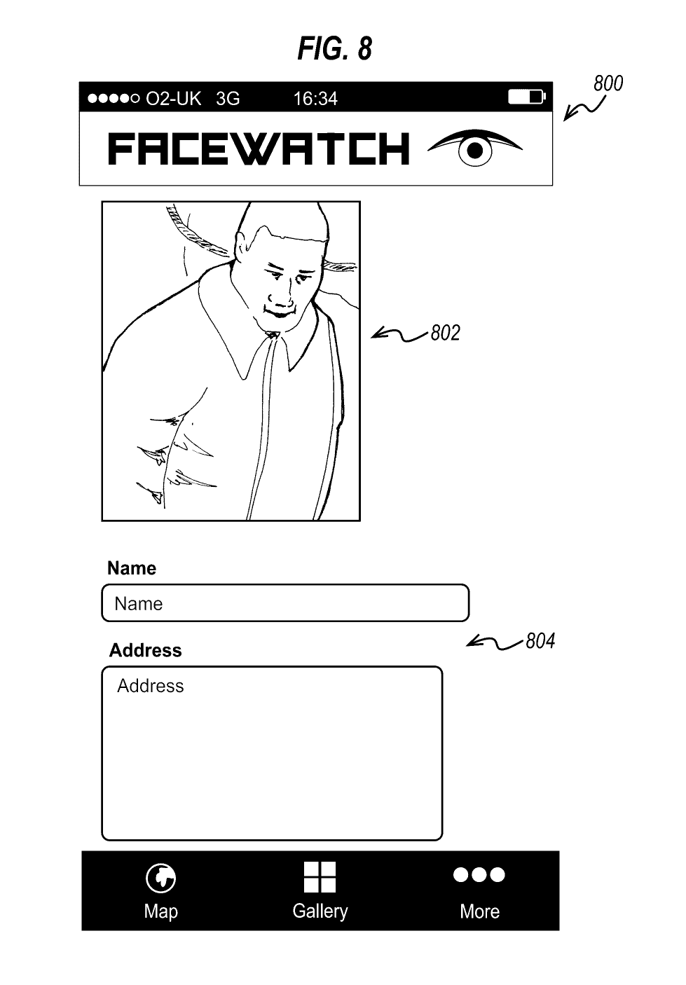

FIG. 8 depicts a third user interface 800, which may be displayed following the selection of a control object 706 in user interface 700. Alternatively, 700 may not be displayed, and user interface 800 may be displayed instead of user interface 700 following the selection of the display object 602a-1 in user interface 600.

The user interface 800 may comprise one or more images 802 associated with the subject data object corresponding to the selected display object, selected from user interface 600. The user interface 800 may further comprise data entry fields 804, which enable a user of the user interface to input information relating to the subject data object. The user interface 800 may further comprise a control object (not shown) such as a button which, when selected, causes the information input into data entry fields 804 to be saved to the subject data object. Alternatively or additionally, selection of the control object may cause the information input into data entry fields 804 to be transmitted to the police or other law enforcement body or agency.

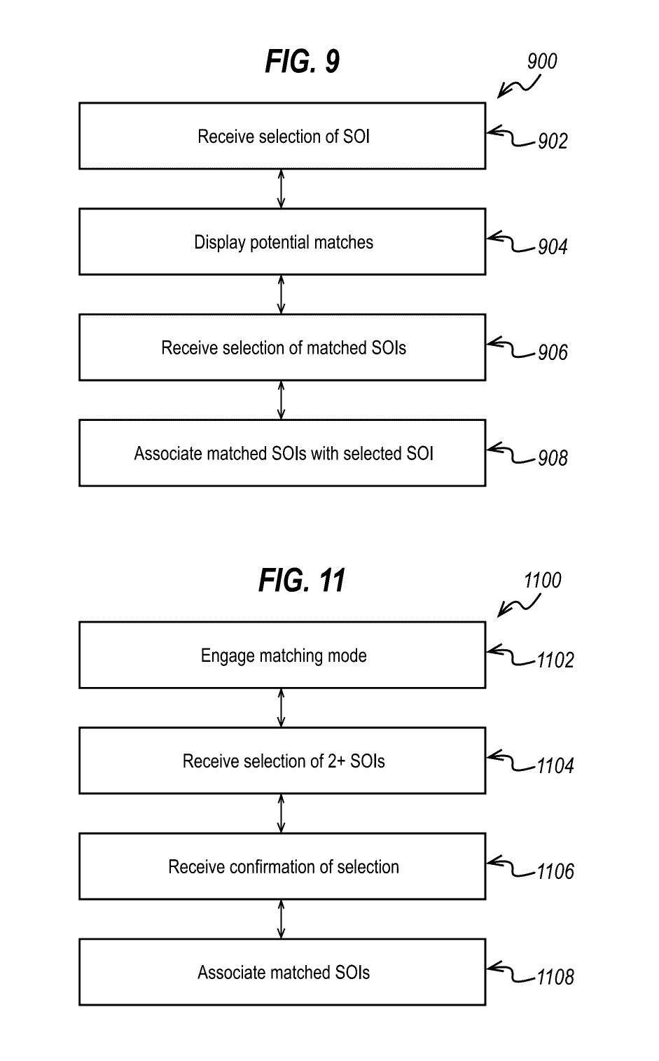

FIG. 9 is a flow diagram 900 depicting a method of matching a first unmatched subject data object with at least one second unmatched subject data objects. The method 900 may be carried out on server 150. When the method 900 is carried out on the server 150, input to the method may be received from the electronic device 110 and communicated to the server 150, and the result of the method 900 may be communicated from the server 150 to the electronic device 110 to be displayed on display device 114. Static information/data required by the method 900, for example databases storing subject data objects, event data objects, etc., may be stored on server 150.

At step 902, a selection of a first unmatched subject data object may be received by the processor 111 or server 150. The selection may be carried out by a user interacting with a user interface displayed on the electronic device 110 via a HID 115. The user interface that the user interacts with to select a first unmatched subject data object may be the watch list 500, depicted in FIG. 5.

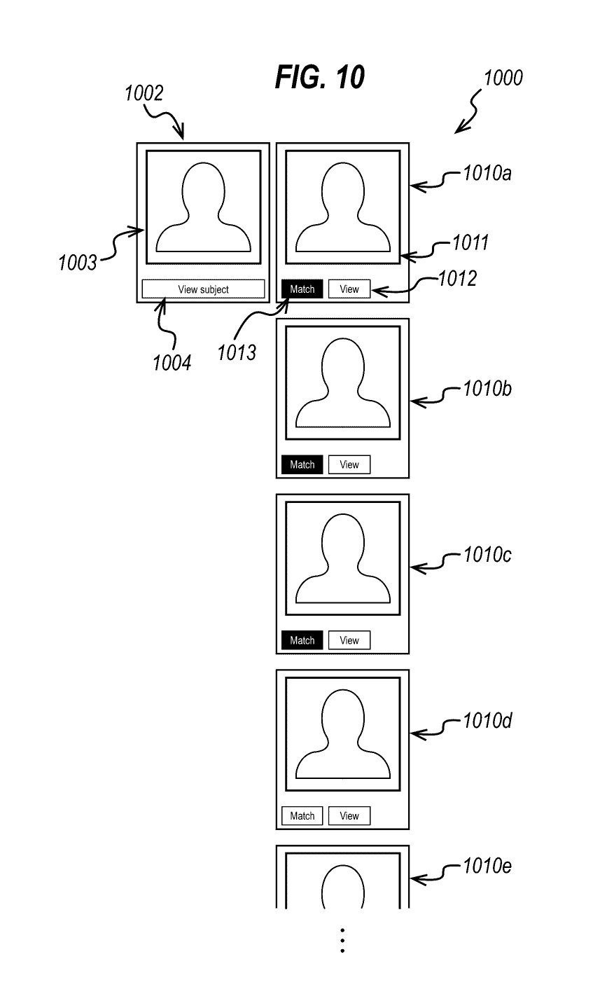

At step 904, at least one second display object corresponding to a second unmatched subject data object that is associated with an event data object other than the event data object which the first unmatched subject data object selected at step 902 is associated with are displayed on display device 114. An example display output at this step is depicted in and described with reference to FIG. 10.

In the context of the present disclosure, the first and second unmatched subject data objects are unmatched in the sense that they have not yet been matched with one another. A previously carried-out matching process may have already matched the first unmatched subject data object with another subject data object. This already-matched subject data object would not be displayed as a second unmatched subject data object because it has already been matched with the first unmatched subject data object. Only subject data objects that have not already been matched with the first unmatched subject data object may be second unmatched subject data objects.

At step 906, a selection of one or more of the second display objects is received by processor 114 and/or server 150. A user selects the one or more second display objects that correspond to second subject data objects that he or she believes relate to the same suspect as the first unmatched subject data object, to which the first display object corresponds. This selection is based, for example, on the images associated with the first unmatched subject data object and the second unmatched subject data objects but may alternatively or additionally be based on identifying data associated with the first and second unmatched subject data objects.

At step 908, the identifying data associated with the first unmatched subject data object and the identifying data associated with the one or more selected second unmatched subject data objects are linked with one another. An example of this link is depicted in FIG. 4 by arrow 408. In this example, subject data objects 404b and 404c of FIG. 4 have been matched in the process described above. The links between matched subject data objects may be represented in a table in a relational database, nodes representing the matched subject data objects may be linked by an edge in a graph database, or any other suitable representation using NoSQL databases or other forms of data storage may be used.

FIG. 10 depicts an example user interface layout 1000 (‘match view’) that may be displayed on display device 114 at steps 904 to 906 of the method depicted in FIG. 9 and discussed above.

In the match view 1000, a first display object 1002 corresponding to a first unmatched subject data object 100 is displayed. The first display object 1002 may comprise one or more images 1003 of the suspect to which the first unmatched subject data object 1002 relates. The first display object 1002 may also be displayed with a button 1004 which, when selected, provides further information associated with the first unmatched subject data object 1002. Alternatively or additionally, selecting the first display object 1002 itself, for example by clicking a mouse cursor anywhere within the boundary of the first display object 1002 or by tapping a touch screen anywhere within the boundary of the first display object 1002, further images associated with the first unmatched subject data object 1002 or further information associated with the first unmatched subject data object 1002 may be displayed.

Also in the match view 1000, second display items 1010a-e, each corresponding to a second unmatched subject data object, 101 are displayed. In the example depicted in FIG. 10, five second display objects are displayed; however, it will be appreciated that any number of second display objects greater than or equal to one may be displayed. Each of the second display objects 1010a-e may be displayed with one or more images 1011 associated with the corresponding second unmatched subject data object. Each second display object 1010a-e may also be displayed with a button 1012 which, when selected, provides further information associated with the second unmatched subject data object 1010a-e with which the button is associated. Alternatively or additionally, selecting a second display object 1010a-e itself, for example by clicking a mouse cursor anywhere within the boundary of the object 1010a-e or by tapping a touch screen anywhere within the boundary of the object 1010a-e, further images associated with the second unmatched subject data object 1010a-e or further information associated with the second unmatched subject data object 1010a-e may be displayed.

Each second display object 1010a-e may also be displayed with a match button 1013. Selecting the match button 1013 may be used to indicate a selection of the second unmatched subject data object with which the match button 1013 is associated for the purposes of matching in step 908 of method 900. Alternatively to displaying further images or information associated with the second unmatched subject data object 1010a-e on selection within the boundary of the second display object 1010a-e, selecting a second display object 1010a-e in this way may perform the same function as the match button 1013.

A determination regarding which second display objects 1010a-e are displayed in match view 1000 for a given first unmatched subject data object associated with the first display object 1002 may be determined based on the identifying data that forms part of the first unmatched subject data 1002 object and the identifying data that forms part of each of the second unmatched subject data objects (i.e. from the set of all possible second unmatched subject data objects, not just the unmatched subject data objects 1010a-e displayed in match view 1000) 100. This determination may form part of method step 906 of method 900. This dependence may be based on height, weight, age, racial, gender, or other identifying data.

Items of identifying data which may take one of a continuous set of values, for example age or height, may be divided into ranges. Other items of identifying data, such as gender or race, which are typically thought of as forming discrete categories, may not be organised into ranges.

For example, if a given first unmatched subject data object has identifying data comprising: male, white, 31-40 years old, then only second display objects corresponding to second unmatched subject data objects with the same identifying data may be displayed. This part of the process may be carried out on server 150.

Alternatively, for particular types of identifying data that are difficult to distinguish, such as age or height, second unmatched subject data objects with the same identifying data or neighbouring identifying data may be displayed. In this respect ‘neighbouring’ identifying data means items identifying data which fall into ranges that are adjacent on a scale. For example, height ranges 5′9″ to 6′0″ and 6′1″ to 6′4″ are adjacent on a scale of increasing height, and are therefore neighbouring ranges. For example, if a first unmatched subject data object 1002 has associated subject data of male, white, 31-40 years old, then second display objects corresponding to second unmatched subject data objects with associated identifying data: male, white, and 21-30 years old, 31-40 years old, or 41-50 years old may be displayed. It will be appreciated that the neighbouring identifying data is not limited to immediately adjacent identifying data and may extended to identifying data that is a two, three, or more neighbours removed from the identifying data that forms part of the first unmatched subject data object.

Additionally, second display objects corresponding to second unmatched subject data objects with associated identifying data that has not been defined may also be displayed with second unmatched subject data objects 1010a-e in match view 1000. For example, if a first unmatched subject data object 1002 has associated identifying data of male, white, 31-40 years old, then second display objects corresponding to second unmatched subject data objects with associated identifying data male, white, undefined age may be displayed.

The user interface 1000 may further comprise controls to enable control of the identifying data used to filter the second unmatched subject data items corresponding second display objects 1010a-e by a user. For example, controls may be provided which enable the user to filter second unmatched subject data objects according to any combination of identifying data. Only second display objects corresponding to second unmatched subject data objects which match the user-defined combination of identifying data will be displayed.

Alternatively or additionally to determining which second display objects are displayed based on identifying data of the corresponding second unmatched subject data object, the determination of which second display objects are displayed may utilise a facial recognition (FR) system. Where there is a match rating between the facial recognition data of the first unmatched subject data object 1002 and a second unmatched subject data object greater than a pre-determined threshold, a second display object 1002 associated with that second unmatched subject data object may be displayed in the match view 1000.

The FR system may provide a match rating which represents a likelihood or probability that a face detected in each of an image associated with a subject data object is the same face as a face detected in the image associated with another subject data object. The FR system may also provide a set of potential matches, i.e. a group of subject data objects whose match ratings with one another or with a common subject data object are greater than a threshold. The FR system may be part of server 130, for example it may be a software application running on server 130, or may be a separate system with which server 130 communicates.

Determining which second display objects are displayed may also additionally or alternatively be carried out according to the geographic locations associated with the event data objects with which the first unmatched subject data object 1002 and second unmatched subject data objects corresponding to the second display objects are related. For example, only second unmatched subject data object associated with event data objects that occurred within a certain pre-determined distance from the event data object associated with the first unmatched subject data object 1002 may be displayed.

The order in which second display objects 1010a-e are displayed may also be determined as part of the method step 906 of method 900.

The order in which second display objects 1010a-e are displayed may be sorted according to the distance between a location at which the event data object associated with the first unmatched subject data object 1002 took place and the locations at which the event data objects associated with second unmatched subject data objects corresponding to second display objects 1010a-e took place.

Alternatively, the order in which second display objects 1010a-e are displayed may be according to the match rating derived from the facial recognition system.

If the first unmatched subject data object 1002 has already been matched with at least one a subject data object, the display object corresponding to that at least one subject data object is not displayed with the second display objects 1001a-e. Display objects corresponding to the one or more already-matched subject data object may be displayed elsewhere in the match view 1000 in a manner which indicates that they are not a potential match or a second display object 1010a-e the corresponds to a second unmatched subject data object. By displaying already-matched subject data objects, the user of the system is presented with multiple images of the same suspect, which may aid in identifying further matches.

FIG. 11 depicts a flow diagram showing an alternative method 1100 for matching a first unmatched subject data object with second unmatched subject data objects. The method 1100 may be implemented instead of the method 900, or as well as the method 900.

At step 1102, a matching mode is optionally engaged. In this mode, a watch list such as that depicted in FIG. 5 may be modified to enable selection of one or more display objects 501a-j corresponding to unmatched subject data objects that a user believes relate to the same suspect. In matching mode, a bin may be displayed where all selected display objects corresponding to unmatched subject data objects are displayed. By physically grouping the selected display objects together in the user interface, it is easier for a user to compare the images associated with the selected unmatched subject data objects to which the selected display objects correspond.

Alternatively, the watch list may automatically enable the selection of display objects 501a-j, which corresponding to unmatched subject data objects, for the purposes of matching without enabling a matching mode. In this case, step 1102 is not carried out. A bin may be displayed once the first display object 501a-j has been selected. Alternatively, a bin may be displayed as part of a watch list prior to the selection of the first display object 501a-j.

At step 1104, a selection of two or more display objects may be received by the server 150. The selection may be carried out by a user interacting with a user interface displayed on display device 114 via a human interface device 115. It may also be possible to de-select selected display objects from the bin and/or from the modified watch list. The display objects 501a-j may be selected and/or de-selected by clicking a mouse cursor or by tapping a touch screen anywhere within the boundary of the display object 501a-j and/or by clicking a mouse cursor or by tapping a touch screen on a button that is associated with a given display object 501a-j.

At step 1106 confirmation is received by the server 150 that the currently selected display objects are matches. This confirmation may be transmitted to the server 150 from the electronic device 110 in response to a button in the user interface being activated. This confirmation may be transmitted from the electronic device 110 to the server 150 simultaneously with the selection at step 1104.

At step 1108 the selected unmatched subject data objects, to which the selected display objects correspond, at the time of confirmation being received at step 1106 are matched or associated with one another in the same manner as described with respect to step 908 of method 900.

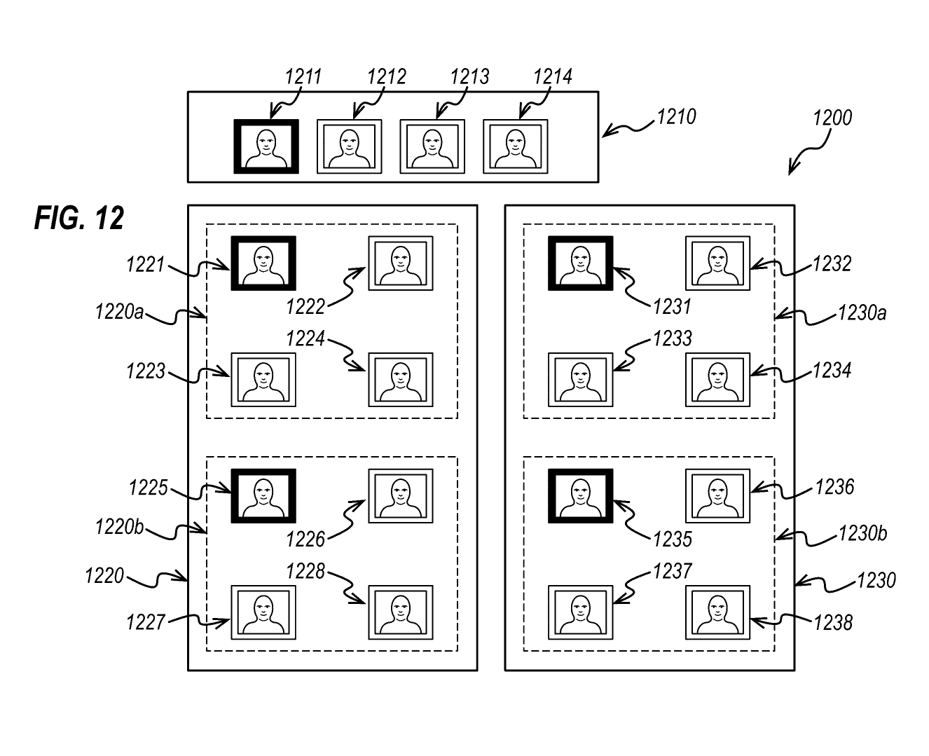

FIG. 12 depicts three domains 1200 within and between which permissions to perform and view the results of matching may optionally be restricted.

Depicted in FIG. 12 are three domains 1210, 1220 and 1230. Each of these domains may be associated with an individual user, multiple users, a group of users, or multiple groups of users. For example, domain 1210 may be associated with Police users, i.e. users who are members of a police force or law enforcement agency. The domain 1220 may be associated with a group of public houses in a certain area, and the domain 1230 with a group of restaurants in a certain area. Within each domain there may exist sub-domains such as sub-domains 1220a and 1220b within domain 1220 and sub-domains 1230a and 1230b within domain 1230. Each of the sub-domains may correspond to an individual premises within the group of public houses of domain 1220 or restaurants of domain 1230. An individual premises may have several users associated with it who are employees or owners of the public house or restaurant.

Also depicted in FIG. 12 are several subject data objects. Subject data objects uploaded by users associated with particular domains and sub-domains may be limited to that domain or sub-domain. For example, in FIG. 1212 subject data objects 1211-1214 have been uploaded by users associated with domain 121220, subject data objects 1221 to 1224 have been uploaded by users associated with sub-domain 1220a within domain 1220, subject data objects 1225 to 1228 have been uploaded by users associated with sub-domain 1220b within domain 1220, subject data objects 1231 to 1234 have been uploaded by users associated with sub-domain 1230a within domain 1230, and subject data objects 1235 to 1238 have been uploaded by users associated with sub-domain 1230b within domain 1230.

Subject data objects 1211, 1221, 1225, 1231 and 1236 are all potential matches for one another. However, which of the potential matches can be seen by which users may be determined according to the domains and sub-domains that each user belongs to. For example, a Police user may be able to see all of the potential matches, a corporate investigator associated with domain 1220 may only be able to see potential matches 1221 and 1225, and a corporate investigator associated with domain 1230 may only be able to see potential matches 1231 and 1235. The visibility of potential matched subject data objects may also be determined on a sub-domain level.

The visibility of potentially matched subject data objects may also be determined according to information associated with the event data object with which each subject data object is associated. For example, police users may only be able to see event data objects (and their associated subject data objects) that have been reported to them as crimes.

Furthermore, the visibility of potentially matched subject data objects may also be restricted according to certain user types. For example, only users designated as police users or ‘Investigators’ may be able to view potential matches generated by an FR system.

In a second aspect of the invention, a system and method for presenting alerts on one or more electronic devices is provided. An alert is a message which may comprise further aspects, such as images, videos, audio files, location data, a telephone number, email address, and/or any other data. The alert may be represented by an alert data object, which comprises the individual data that make up the alert such as text data and image/video/audio data.

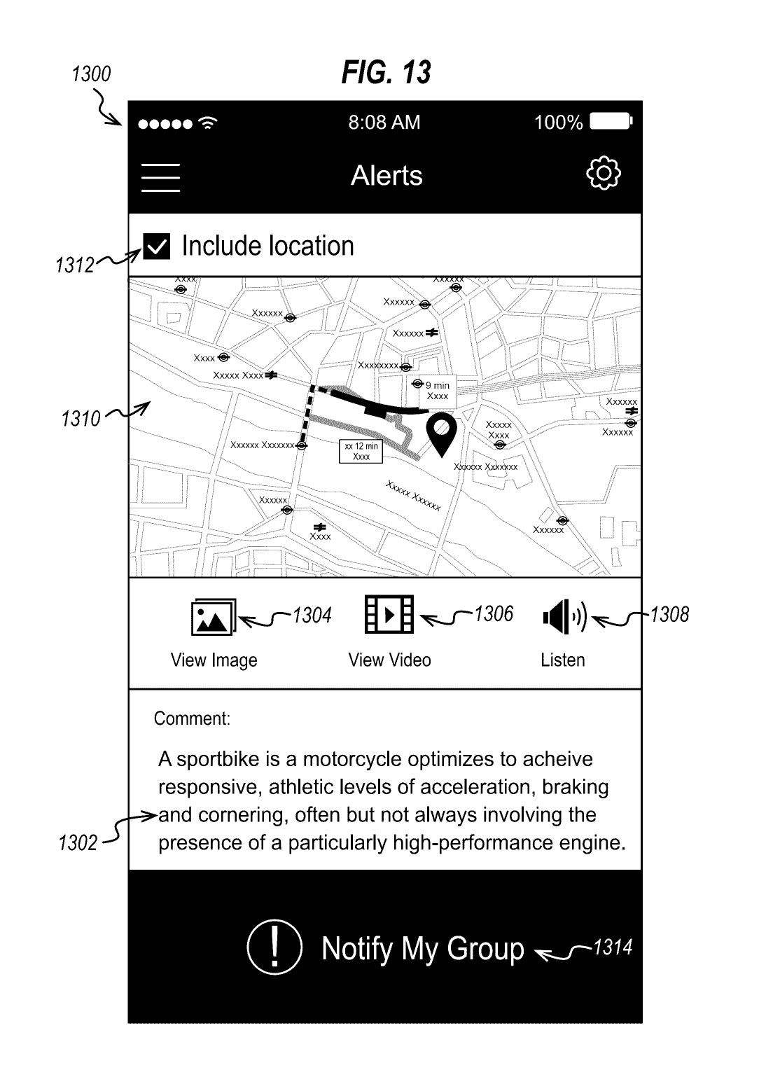

FIG. 13 depicts an example user interface 1300 that may be used to input data to generate an alert. The user interface 1300 may be presented by an application running on an electronic device 110, such as a mobile phone. The user interface 1300 comprises a text entry field 1302. A user interacting with the user interface 1300 may input text into text entry field using a soft or hard keyboard or any other form of text-entry hardware or software. The user interface 1300 also comprises control objects 1304, 1306, 1308 which allow a user to include various file types with the alert. In the specific example depicted in FIG. 13, the user is provided with options to include an image, video, or audio file. It will be appreciated that an alert may be configured to include any other type of electronic file in that case an appropriate control object may be provided in a user interface to enable a user to include the file.

Also in user interface 1300 there is depicted a map 1310 which shows the current location of the electronic device 110 on which the user interface 1500 is displayed. Map 1510 may include an option, in this specific example check box 1512, which the user may select to indicate that they wish to include the displayed location in the alert.

The user interface 1310 further comprises a control object 1314 which is used to indicate that the information entry to the user interface 1310 is complete and that the information input should be transmitted to a second electronic device 110 or server 130. The information that is input may be encapsulated into an alert data object, which comprises all of the input information, by the electronic device 110 on which the user interface 110 is displayed. Alternatively, the information input via the user interface 110 may simply be transmitted to the server 130 as individual data objects and the server 130 may determine which objects are to form the alert data object and may generate the alert data object itself.

Other information not input via the user interface may also be sent to the second electronic device 110 or server 130. For example, one or more of the following may also be included: a phone number associated with the mobile phone on which the information was input, a user account associated with the electronic device, a group or group ID associated with the electronic device or user account, and/or a time at which the information was submitted.

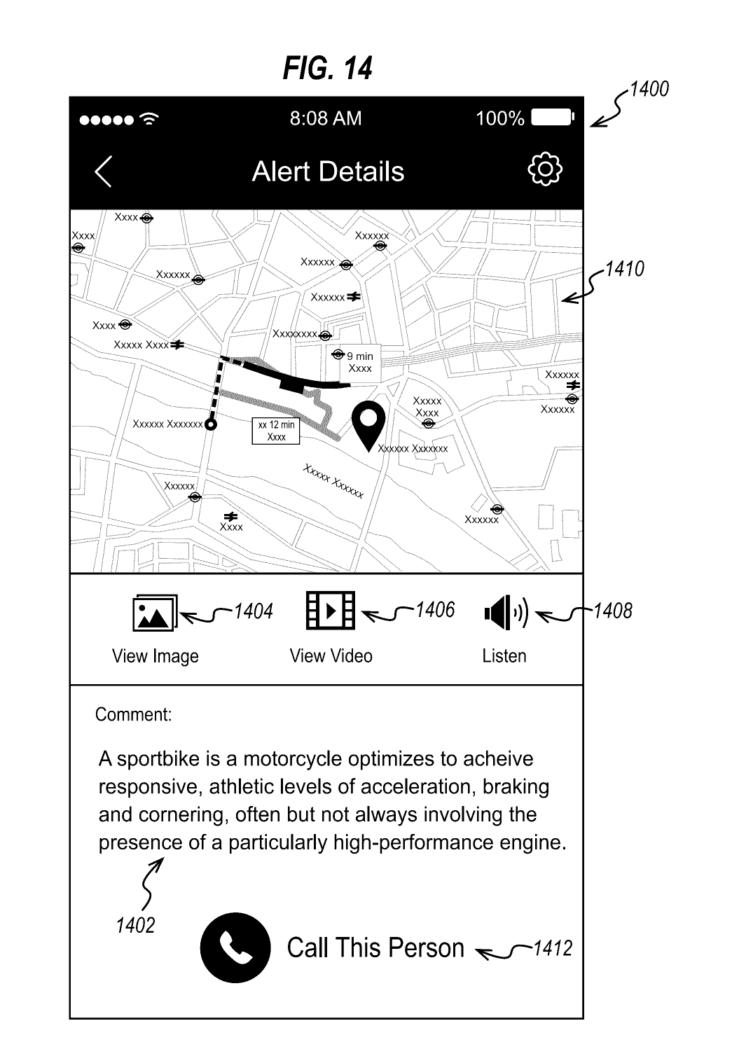

FIG. 14 depicts another example user interface 1400 that may be used on an electronic device 110 to display alerts received from other electronic devices 110, or from a server 130. For example, the user interface 1400 may be used to display alerts that comprise information input using user interface 1300 depicted in FIG. 13 and relating to the electronic device 110 on which the information was input.

The user interface 1400 may comprise a text field 1402 displays the text content of an alert. The text content of the alert may be a text data that forms part of the alert data object. The text data may comprise the text entered in text entry field 1302 of user interface 1300. User interface 1400 also comprises a map 1410, which is displayed simultaneously with the text data and on which a location that may form part of the alert data object is displayed.

The user interface 1400 may also comprise control objects 1404, 1406, 1408 which cause, on selection, the user interface 1400 to change to display or play the image, video or audio data that is included in the alert data object. The image, video or audio data may be the image, video or audio file included in the alert via user interface 1300.

If the alert data object includes a telephone number associated with the device from which the displayed alert originated, the user interface 1400 may further comprise a control object 1412, which enables the user of the device on which user interface 1400 is displayed to place a telephone call to the user of the device on which user interface 1300, used to create the alert, was displayed.

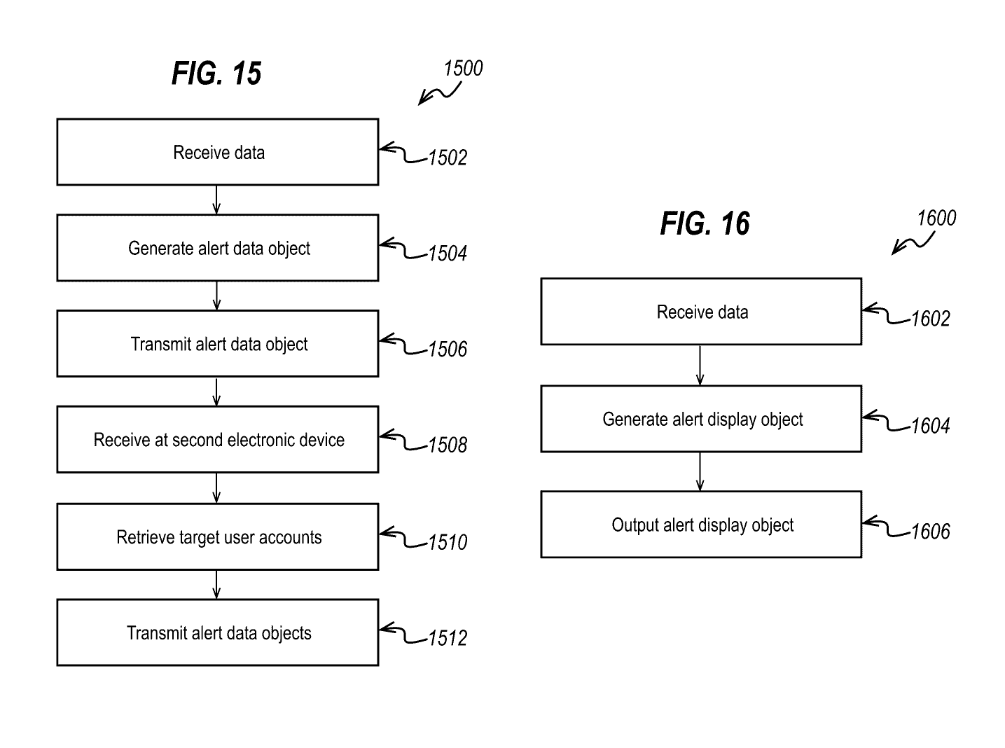

FIG. 15 depicts a flow diagram of a method for generating and transmitting alert data objects in correspondence with the user interface 1300 discussed above.

At step 1502, the electronic device on which user interface 1300 is displayed receives location data, text data, and one or more of: audio data, video data and image data. The text data may be received via a graphical user interface that is part of the electronic device such as a soft or hard keyboard, the location data may be received from a positioning system that is part of the electronic device, such as GPS, A-GPS, WPS or any other positioning system. The audio, video and image data may be retrieved from memory on the electronic device or may be captured using a camera and/or microphone that are part of the electronic device.

At step 1504, the electronic device generates an alert data object by encapsulating the data received at step 36 into an alert data object. Step 1504 may further comprise including user account data associated with the electronic device in the alert data object and/or a group ID with which the electronic device is associated with or which is the target of the generated alert data object.

At step 1506, the alert data object is transmitted to a second electronic device. The second electronic device may be a server such as server 130 depicted in FIG. 1.

Further optional steps 1508 to 1512 may also from part of method 1500. At step 1508, the alert data object is received by the second electronic device. At step 1510, the second electronic device retrieves from a memory with which it is communicatively coupled one or more target user accounts. The target user accounts are user accounts that are associated with the user account data or group ID that is contained in the received alert display object. If the received alert display object contains user account data, not a group ID, then a group ID may be retrieved from memory associated with the second electronic device. The target user accounts are other user accounts that are associated with the retrieved group ID. If the received alert display object contains a group ID, then the target user accounts are those user accounts that are associated with the received group ID. The associated between user accounts and groups may be stored in a database in the memory of the second electronic device, or in any other form of non-volatile storage.

At step 1512, the alert data object is transmitted from the second electronic device to one or more target electronic devices that are associated with the target user accounts retrieved at step 1510.

FIG. 16 depicts a flow diagram of a method for receiving and displaying the alert data objects generated in method 1500, and in accordance with the user interface depicted in FIG. 14.

At step 1602, the electronic device, e.g. a target electronic device in the method 1500 above, receives an alert data object from a second electronic device or server. The alert data object comprises comprising text data, location data and one or more of: image data, video data, and audio data, as discussed above.

At step 1604, the electronic device generates an alert display object from the data contained in the alert data object. The alert display object may be a user interface, such as user interface 1400 depicted in FIG. 14.

At step 1606, the electronic device outputs on a display connected to it the alert display object. The text data is displayed on the display simultaneously with the location data and one or more control object that cause the one or more of image data, video data and audio data to be displayed when selected.

The alert data object received at step 1602 may further comprise a telephone number associated with the first electronic device discussed above with respect to FIG. 15, in which case the step of generating the alert display object may further comprise generating a control object that is configured to establish a telephone call using the received telephone number. The telephone control object is displayed simultaneously with the location data and text data.

Alternatively to the alert data object comprising the video, image or audio data, the alert data object may not comprise video data, image data, or audio data, but instead control objects configured to retrieve and display or output the video data, image data and/or audio data are generated at step 1604 and displayed simultaneously with the text data and the location data and any other control objects, such as the telephone control object discussed above.

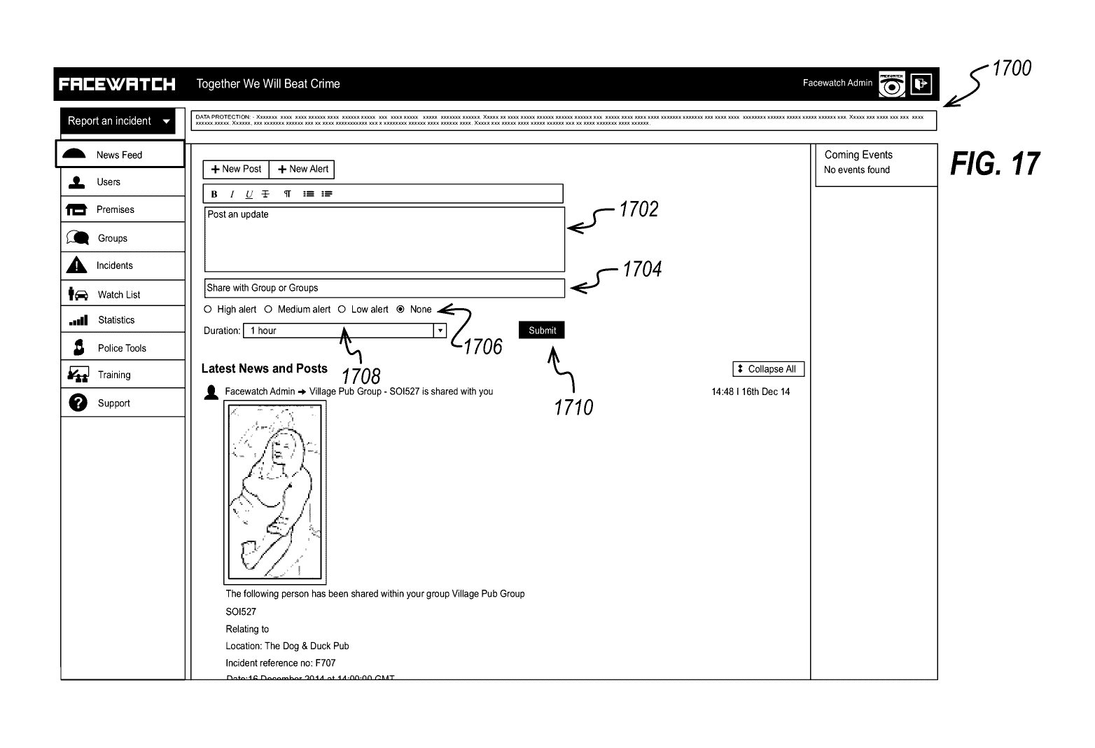

An alternative user interface 1700 for inputting information and creating an alert is depicted in FIG. 17. User interface 1700 may be provided in a web browser. User interface 1700 comprises a text entry field 1702. A user interacting with the user interface 1700 may input text into text entry field using a soft or hard keyboard, or any other form of text-entry hardware or software.

User interface 1700 may also comprise a group entry/selection field 1704. By entering a group ID or selecting a group from a list in field 1704, the target users to which the alert will be sent can be input.

Each alert may have a corresponding priority, for example: high alert, medium alert, low alert, or none. The priority of the alert may be created using priority control object 1706 in user interface 1700. In the example user interface 1700 depicted in FIG. 17, the priority control object 1706 is provided as a series of radio buttons.

An alert may also have a corresponding expiry time or duration, i.e. a time period for which the alert will be display or after which the alert will no longer be displayed to target users. In user interface 1700, the alert expiry time may be set using drop-down box 1708.

Once a user has completed inputting information to the user interface 1700 and wishes to create the alert, the user may select submit button 1710. In the example where user interface 1700 is provided by a web page displayed in a web browser, the user interface 1700 may be a HTML form which is submitted via a HTTP PUT or GET request to the server 130. The server 130 may then assemble the data provided in the various fields of the form into an alert data object. The alert data object may then transmitted to the relevant target user devices.

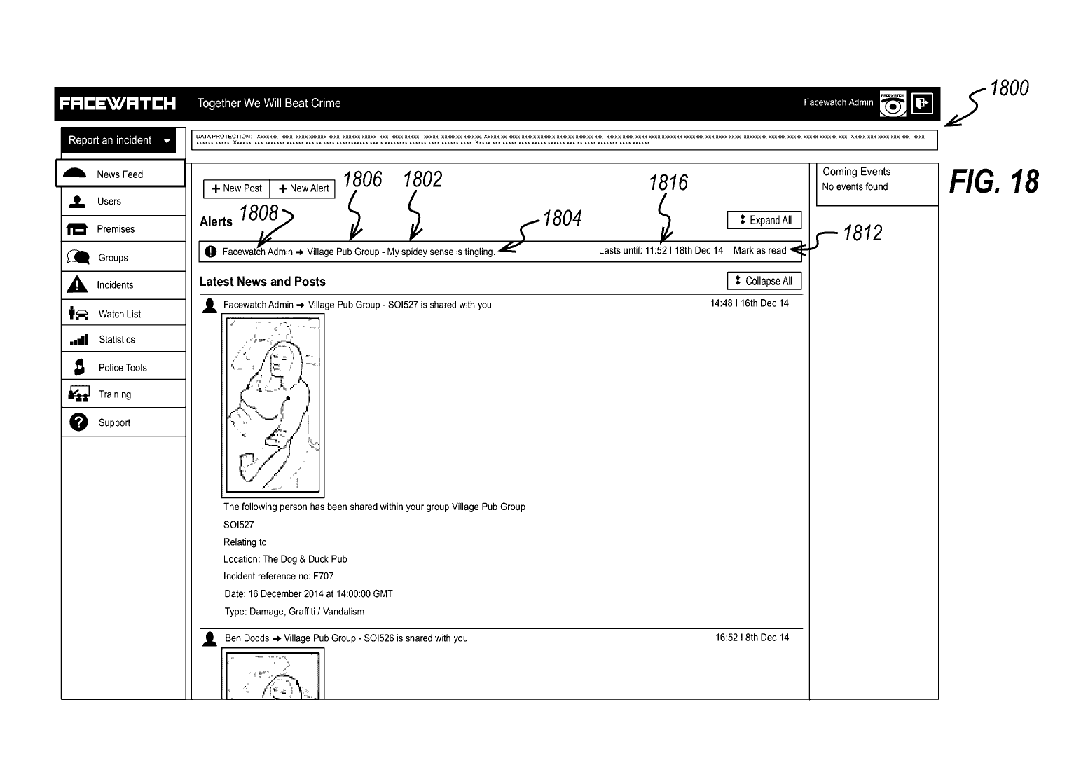

The target user devices may also employ a web browser to view alerts. An example user interface 1800 that displays alerts, and which may be provided by a web page displayed in a web browser, is depicted in FIG. 18. A single alert 1802 is displayed in user interface 1800, though it will be appreciated that more than one alert may be displayed concurrently.

The alert display object 1802 comprises a text object 1804 which displays the content of the alert as may be input using field 1702 of user interface 1700. The alert display object may also comprise a group ID object 1806, which displays the group to which the alert was sent, and a user ID object 1808, which displays the user account from which the alert was sent.

The alert display object 1802 may further comprise an expiry time object 1810, which displays the time and date at which the alert will expire, and/or a control object 1812 which enables a user of the user interface 1800 to mark the alert as read. Marking the alert as read may dismiss the alert so that it is no longer displayed in user interface 1800, or may remove some graphical highlighting from the alert display object.

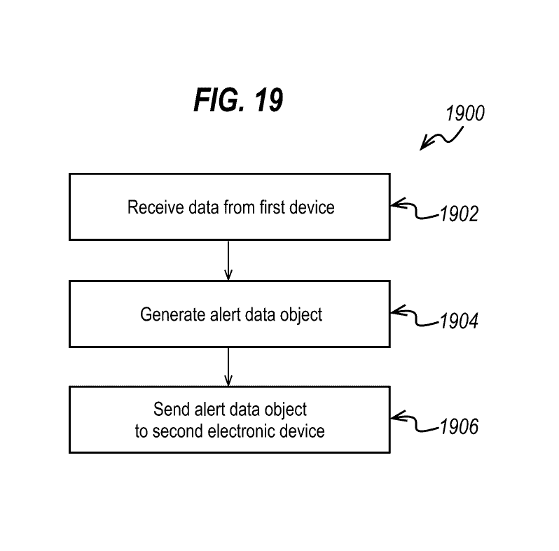

FIG. 19 depicts a flow diagram showing a method for generating alerts and transmitting the generated alerts to one of more electronic devices corresponding to the user interfaces described with respect to FIGS. 17 and 18. The method depicted in FIG. 19 may be carried out on a server 130 that is in communication with one or more electronic devices 110 via a network 120.

At step 1902, data is received from a first electronic device. The first electronic device may be the device on which user interface 1700 is displayed. The data that is received comprises text data and alert time data. The text data may comprise a message that is to be displayed as part of an alert. The data received at step 1902 may further comprise one or more of: a user ID that is associated with the first electronic device or a user of the first electronic device; a group ID that is associated with a group to which the first electronic device or user of the first electronic device is a member; a location; an image; a video; an audio file; a telephone number; and an alert expiry time. The alert time data defines a time period for which the alert data object should be display on a display connected to the third electronic device.

At step 1904, an alert data object is generated based on the data received from the first electronic device at step 1902. The alert data object may comprise either the text data object or the message contained in the text data object. The alert data object may further comprise any of the other data items that were received from the first electronic device.

The generated alert data may comprise the user ID associated with the first electronic device or a user of the first electronic device, and may also comprise a group ID associated with a group to which the alert is to be sent. Alternatively, the first electronic device may be associated with a user ID in a database stored on server 130. The user ID associated with the first electronic device may be retrieved from the database and included in the generated alert data. A group ID for a group that the first electronic device, user of the first electronic device, or user ID is associated with may also be stored in a database on server 130 and retrieved from the database and included in the generated alert data.

At step 1906, the alert data object generated at step 1904 is stored in a memory associated with the second electronic device. The memory may be a database stored on a hard disk or solid state drive or another non-volatile storage medium.

At step 1908, the second electronic device receives a request from a third electronic device for alter data objects. The third electronic device may be the device on which user interface 1800 is displayed. Optionally, the request that is received from the third electronic device may include user account data or a group ID that is associated with the third electronic device. If the request contains a group ID, the second electronic device may determine whether any alert data objects stored in memory contain the group ID and provide then transmit any such alert data objects to the third electronic device in step 1910. If the request includes user account data, a group ID may be retrieved from a memory associated with the second electronic device and then used to determine if any alert data objects stored in the memory contain the group ID and should be transmitted to the third electronic device at step 1910. Alternatively, the second electronic device may simply transmit all alert data objects stored in memory to the third electronic device at step 1910.

Step 1902 may further comprise receiving alert creation time data. The alert creation time data is the time at which the data is transmitted to the first electronic device from the second electronic device. If so, step 1904 may include calculating alert expiry time data by adding the alert time data to the alert creation time, such that the alert expiry time data defines a time after which the alert data object should no longer be displayed on the display connected to the third electronic device. Alternatively, at step 1902 an alert expiry time may be transmitted to the first electronic device from the second electronic device rather than alert time data and included in the generated alert data object.

Further alternatively, the alert time data may not be included in the generated alert data object and may instead define a length of time for which the alert is to be stored in the memory of the first electronic device. In this case, after the expiry of the time provided by the alert time data, the first electronic device may remove the alert data object from memory. Since the alert data object is removed from memory, it will not be transmitted to or displayed on the third electronic device when further requests are made.

The following is a non-exhaustive list of embodiments which may or may not be claimed:
1. A computer-implemented method comprising:
   receiving subject data objects from a first electronic device;
   receiving event data objects from a second electronic device;
   associating each subject data object with a single event data object;
   associating each event data object with one or more of the subject data objects;
   generating unmatched subject data objects comprising for each subject data object at least a portion of the each subject data object and at least a portion of the single event data object associated with the subject data object; and
   sending, to a third electronic device, the unmatched subject data objects for display at the third electronic device.
2. The method of embodiment 1, further comprising:
   receiving, from the third electronic device, match data comprising indications of two or more unmatched subject data objects; and
   associating the each unmatched subject data object contained in the match data with each of the other unmatched subject data objects contained in the match data.
3. The method of embodiment 2, wherein the match data further comprises an indication of the first unmatched subject data object.
4. The method of embodiment 2 or 3, wherein the match data corresponds to one or more subject data objects each associated with one of the one or more unmatched subject data objects that relate to the same suspect.
5. The method of any one of embodiments 2 to 4, further comprising, prior to the step of receiving match data:
   receiving, from the third electronic device, a selection pertaining to a first unmatched subject data object;
   determining whether at least one second subject data object sufficiently matches the first subject data object corresponding to the first unmatched subject data object;
   generating at least one second unmatched subject data object comprising for each of the at least one second subject data objects at least a portion of the at least one second subject data object and at least a portion of the single event data object associated with the second subject data object; and
   sending, to the third electronic device, the first unmatched subject data object and the at least one second unmatched subject data object for display at the third electronic device.
6. The method of embodiment 5, wherein the step of determining comprises filtering subject data objects that are associated with event data objects other than the event data object associated with the first unmatched subject data object; and
   wherein the at least one second subject data object is selected from the filtered subject data objects and has one or more elements of subject data in common with the first subject data object associated with the first unmatched subject data object.
7. The method of embodiments 5 or 6, wherein subject data objects comprise at least one image, and the step of determining further comprises performing an image matching process to generate, for each of the second subject data objects other than the first subject data object associated with the first unmatched subject data object, a match rating which represents a likelihood that an image object in the image associated with the second subject data object is the same as an image object in image associated with the first subject data object, and wherein second unmatched subject data objects are generated for second subject data objects with a match rating greater than a threshold.
8. The method of any of embodiments 4 to 7, wherein the at least one second unmatched subject data object comprises two or more second unmatched subject data objects, and the second unmatched data objects are sorted into a display order, which forms part of each second unmatched subject data object.
9. The method of embodiment 8, wherein the display order of second unmatched subject data objects is sorted according to the match rating.
10. The method of embodiment 8, wherein event data objects comprise location data corresponding to the location of the event, and wherein the display order of second unmatched subject data objects is sorted according to a geographical distance between the location associated with the first event data object associated with the first unmatched subject data object and the location associated with the second event data object associated with each second unmatched subject data object.
11. The method of any preceding embodiment, wherein:
   the first, second and third electronic devices are the same electronic device; or
   the first, second and third electronic devices are different electronic devices; or
   the first and second electronic devices are the same electronic device which is different to the third electronic device; or
   the first and third electronic devices are the same the same electronic device which is different to the second electronic device; or
   the second and third electronic devices are the same electronic device which is different to the first electronic device.
12. The method of any preceding embodiment, wherein each subject data object corresponds to a person, vehicle, or other entity suspected of involvement in a crime.
13. The method of any preceding embodiment, wherein each event data object corresponds to a crime that has been committed, or other event data object that has occurred.
14. The method of any preceding embodiment, wherein the subject data comprises one or more images.
15. The method of embodiment 14 when dependent on embodiment 12, wherein the one or more images depict the person, vehicle, or other entity suspected of involvement in a crime.
16. The method of embodiment 14 when dependent on embodiment 13, wherein the one or more images are images captured by premises at which the event occurred.
17. A computer-implemented method comprising:
   receiving, from a first electronic device, one or more first unmatched subject data objects;
   outputting, on a display, the one or more first unmatched subject data objects;
   receiving input pertaining to the one or more selected first unmatched subject data objects selected from the first unmatched subject data objects;
   sending, to the first electronic device, an indication of the one or more selected first unmatched subject data objects,
   wherein each unmatched subject data object comprises at least a portion of a subject data object and at least a portion of a single event data object associated with the subject data object,
   wherein each subject data object is associated with a single event data object; and
   wherein each event data object is associated with one or more of the subject data objects.
18. The method of embodiment 17, wherein the input pertaining to one or more selected first unmatched subject data objects pertain to two or more selected first unmatched subject data objects, and wherein the indication of the two or more selected first unmatched subject data objects forms match data.
19. The method of embodiment 17, further comprising, wherein the input pertaining to one or more selected first unmatched subject data objects pertains to one selected first unmatched subject data object, and further comprising, following sending the selected first unmatched subject data object:
   receiving, from the first electronic device, one or more second unmatched subject data objects and the selected first unmatched subject data object;
   outputting, on the display, the selected first unmatched subject data object and the one or more second unmatched subject data objects;
   receiving input pertaining to one or more selected second unmatched subject data objects selected from the second unmatched subject data objects;
   sending, to the first electronic device, match data comprising an indication of the one or more selected second unmatched subject data objects.
20. The method of embodiment 17, wherein the match data further comprises an indication of the selected first unmatched subject data object.
21. The method of embodiment 17 or embodiment 18, wherein the second step of outputting on the display comprises outputting the one or more second unmatched subject data objects in a display order.
22. The method of embodiment 19, wherein the display order is received from the first electronic device at the step of receiving the one or more second unmatched subject data objects.
23. The method of any one of embodiments 15 to 22, wherein the step of receiving input comprises receiving a tap and/or gesture from a touch-sensitive display, or receiving a click from a computer mouse, or receiving a key press from a computer keyboard.
24. The method of any one of embodiments 15 to 23, wherein the step of outputting comprises rendering a web page in a web browser.
25. An electronic device comprising processing circuitry configured to perform the steps of any one of the methods of any preceding embodiment.
26. A computer-readable medium comprising computer executable instructions executable by processing circuitry, which, when executed, cause the processing circuitry to perform the steps of any one of the methods of any preceding embodiment.
27. A graphical user interface comprising:
   a first display item corresponding to a first unmatched subject data object, and one or more second display items, each second display item corresponding to a second unmatched subject data object;
   wherein the first display items comprises at least one image associated with the first unmatched subject data object and the one or more second display items each comprise at least one image associated with the corresponding second unmatched subject data object;
   wherein each of the one or more second display items is selectable by a user via the graphical user interface, and wherein upon selection of one or more second display items, the graphical user interface is configured to provide an instruction to a database manager to create an association between the second unmatched subject data objects corresponding to the one or more selected second display items and the first unmatched subject data object.
28. The graphical user interface of embodiment 27, wherein the first unmatched subject data object and one or more second unmatched data objects are associated with event data objects, wherein the event data objects comprise one or more of location data corresponding to the location of the event and date or time data at which the event occurred.
29. The graphical user interface of embodiment 28, wherein the graphical user interface is configured to sort the one or more second display items according to a geographical distance between the location associated with the first event data object associated with the first unmatched subject data object and the location associated with the second event data object associated with each second unmatched subject data object.
30. The graphical user interface of embodiment 28, wherein the graphical user interface is configured to sort the one or more second display items according to the date or time data associated with the second event data object associated with each second unmatched subject data object.
31. The graphical user interface of embodiment 28, further comprising a filtering control object that allows a user to filter the second display objects according to one or more attributes of the second unmatched subject data object and/or event data object associated with the second unmatched subject data object associated with each second display object.
32. The graphical user interface of embodiment 28 or 31, further comprising a sorting control object that allows a user to sort the second display objects according to one or more attributes of the second unmatched subject data object and/or event data object associated with the second unmatched subject data object associated with each second display object.
33. A system comprising the graphical user interface of any one of embodiments 27 to 32.
34. The system of embodiment 33, further comprising a facial recognition system, and wherein the graphical user interface is configured to sort the one or more second display items according to a match rating provided by a facial recognition subsystem.
35. The system of embodiment 34, wherein the graphical user interface is configured to display only second display items with a match rating higher than a pre-determined threshold.
36. A computer-implemented method comprising:
   receiving, on an electronic device, location data, text data, and one or more of: audio data, video data and image data;
   generating an alert data object comprising the location data, text data, and one or more of audio data, video data and image data, and further comprising user account data associated with a user of the electronic device;
   transmitting, to a second electronic device, the alert data object.
37. The method of embodiment 36, further comprising the steps:
   receiving, at the second electronic device, the alert data object;
   retrieving, by the second electronic device, one or more target user accounts associated with the user account contained in the alert data object from a memory communicatively coupled to the second electronic device; and
   transmitting the alert data object from the second electronic device to one or more target electronic devices associated with the target user accounts.
38. The method of embodiment 37, wherein the alert data object generated by the first electronic device also comprises a group ID identifying a plurality of target user accounts, and wherein the step of retrieving comprises retrieving, from the memory associated with the second electronic device, the target user accounts associated with the group ID.
39. The method of embodiment 37, wherein the step of retrieving further comprises retrieving a group ID identifying a plurality of target user accounts from the memory communicatively coupled to the second electronic device based on the user account contained in the alert data object; and retrieving, from the memory communicatively coupled to the second electronic device, the target user accounts associated with the group ID.
40. The method of any one of embodiments 36 to 39, wherein the step of generating further comprises including in the alert data object a telephone number associated with the first electronic device.
41. The method of any one of embodiments 36 to 40, wherein the location data is a location of the device as measured by one of: GPS, A-GPS, WPS or any other positioning system.
42. The method of embodiment 41, wherein the location of the first device is displayed on a map prior to generating and/or transmitting the alert data object.
43. A computer-implemented method comprising:
   receiving, by an electronic device, an alert data object, the alert data object comprising text data, location data and data pertaining to one or more of: image data, video data, and audio data;
   generating an alert display object corresponding to the alert data object;
   outputting, on a display associated with the electronic device, the alert display object, wherein text data is displayed on the display simultaneously with the location data and one or more control objects that cause the one or more of image data, video data and audio data to be accessed when selected.
44. The method of embodiment 43, wherein the location data is displayed on a map.
45. The method of any of embodiments 43 and 44, wherein the alert data object further comprises a telephone number associated with a second electronic device, and wherein a control object configured to establish a telephone call using the telephone number associated with the second electronic device is displayed simultaneously with the location data and text data.
46. The method of any of embodiments 43 to 45, wherein the data pertaining to video data, image data, or audio data is a link to a network location, and wherein the control objects are configured to retrieve from the network location when selected.
47. A computer-implemented method device comprising:
   receiving, at a first electronic device, text data and alert time data from a second electronic device;
   generating an alert data object, wherein the alert data object comprises the text data and alert time data;
   storing, in a memory of the first electronic device, the alert data object;
   receiving, from a third electronic device, a request for alert data objects;
   transmitting, to the third electronic device, the alert data object;
   wherein the alert time data defines a time period the alert data object should be displayed on a display connected to the third electronic device.
48. The method of embodiment 47, wherein the step of receiving includes receiving alert creation time data, wherein the alert creation time data is the time at which the data is transmitted to the first electronic device.
49. The method of embodiment 48, wherein the step of generating includes calculating alert expiry time data by adding the alert time data to the alert creation time data, wherein the alert expiry time data defines a time after which the alert data object should no longer be displayed on a display connected to the third electronic device.
50. The method of embodiment 47, wherein, at the step of receiving, the alert time data is alert expiry time data which defines a time after which the alert display object, and wherein the alert expiry time data is included in the generated alert display, wherein the alert expiry time data defines a time after which the alert data object should no longer be displayed on a display connected to the third electronic device.
51. The method of any one of embodiments 47 to 50, wherein the step of receiving includes receiving alert priority data, and the alert priority data is included in the generated alert data object.
52. The method of any one of embodiments 47 to 51, wherein the alert time data defines a time period for which the alert data object is to be stored in the memory.
53. The method of any one of embodiments 47 to 52, wherein the step of transmitting includes retrieving from the memory any alert data objects and transmitting all retrieved alert data objects to the third electronic device.
54. The method of embodiment 53, wherein the alert time data defines a time period for which the alert data object is to be flagged as active in the memory, and only alert data objects flagged as active are retrieved from the memory and transmitted to the third electronic device.
55. The method of any one of embodiments 47 to 54, wherein the data received from the second electronic device includes a group ID, the request includes user account data associated with the third electronic device, wherein the generated alert data object includes the group ID and wherein the step of transmitting includes retrieving a group ID associated with the user account data from a memory associated with the first electronic device and transmitting only those alert data objects stored in memory which have a corresponding group ID.
56. The method of any one of embodiments 47 to 54, wherein the data received from the second electronic device includes first user account data associated with the second electronic device, the request includes second user account data associated with the third electronic device, wherein the step of generating includes retrieving a group ID associated with the user account data from a memory associated with the first electronic device, wherein the generated alert data object includes the group ID and wherein the step of transmitting includes retrieving a group ID associated the second user account data from a memory associated with the first electronic device and transmitting only those alert data objects stored in memory which have a corresponding group ID.
57. The method of any one of embodiments 47 to 54, wherein the data received from the second electronic device includes a first group ID, the request includes a second group ID associated with the third electronic device, wherein the generated alert data object includes the first group ID and wherein the step of transmitting comprises transmitting only those alert data objects stored in memory which have a the second group ID.

I claim:

1. A computer-implemented method comprising:
receiving, from a first electronic device, subject data objects;
receiving, from a second electronic device, event data objects;
associating each subject data object with a single event data object;
associating each event data object with one or more of the subject data objects;
generating, for each subject data object, an unmatched subject data object comprising at least a portion of a corresponding one of the subject data object and at least a portion of the single event data object associated with the subject data objects; and
sending, to a third electronic device, the unmatched subject data objects for display at the third electronic device.

2. The method of claim 1, further comprising:
receiving, from the third electronic device, match data comprising indications of two or more unmatched subject data objects; and
associating the each unmatched subject data object contained in the match data with each of the other unmatched subject data objects contained in the match data.

3. The method of claim 2, wherein the match data further comprises an indication of the first unmatched subject data object.

4. The method of claim 2, wherein the match data corresponds to one or more subject data objects each associated with one of the one or more unmatched subject data objects that relate to the same suspect.

5. The method of claim 2, further comprising, prior to the step of receiving match data:
receiving, from the third electronic device, a selection pertaining to a first unmatched subject data object;
determining whether at least one second subject data object sufficiently matches the first subject data object corresponding to the first unmatched subject data object;
generating at least one second unmatched subject data object comprising for each of the at least one second subject data objects at least a portion of the at least one second subject data object and at least a portion of the single event data object associated with the second subject data object; and
sending, to the third electronic device, the first unmatched subject data object and the at least one second unmatched subject data object for display at the third electronic device.

6. The method of claim 5, wherein the step of determining comprises filtering subject data objects that are associated with event data objects other than the event data object associated with the first unmatched subject data object; and
wherein the at least one second subject data object is selected from the filtered subject data objects and has one or more elements of subject data in common with the first subject data object associated with the first unmatched subject data object.

7. The method of claim 5, wherein subject data objects comprise at least one image, and the step of determining further comprises performing an image matching process to generate, for each of the second subject data objects other than the first subject data object associated with the first unmatched subject data object, a match rating which represents a likelihood that an image object in the image associated with the second subject data object is the same as an image object in image associated with the first subject data object, and wherein second unmatched subject data objects are generated for second subject data objects with a match rating greater than a threshold.

8. The method of claim 4, wherein the at least one second unmatched subject data object comprises two or more second unmatched subject data objects, and the second unmatched data objects are sorted into a display order, which forms part of each second unmatched subject data object.

9. The method of claim 8, wherein the display order of second unmatched subject data objects is sorted according to the match rating.

10. The method of claim 8, wherein event data objects comprise location data corresponding to the location of the event, and wherein the display order of second unmatched subject data objects is sorted according to a geographical distance between the location associated with the first event data object associated with the first unmatched subject data object and the location associated with the second event data object associated with each second unmatched subject data object.

11. The method of claim 1, wherein:
the first, second and third electronic devices are the same electronic device; or
the first, second and third electronic devices are different electronic devices; or
the first and second electronic devices are the same electronic device which is different to the third electronic device; or
the first and third electronic devices are the same the same electronic device which is different to the second electronic device; or
the second and third electronic devices are the same electronic device which is different to the first electronic device.

12. The method of claim 1, wherein each subject data object corresponds to a person, vehicle, or other entity suspected of involvement in a crime.

13. The method of claim 1, wherein each event data object corresponds to a crime that has been committed, or other event data object that has occurred.

14. The method of claim 1, wherein the subject data objects comprises one or more images.

15. The method of claim 14, wherein each event data object corresponds to a crime that has been committed, or other event data object that has occurred, and wherein the one or more images depict the person, vehicle, or other entity suspected of involvement in a crime.

16. The method of claim 14, wherein each event data object corresponds to a crime that has been committed, or other event data object that has occurred, and wherein the one or more images are images captured by premises at which the event occurred.

17. An electronic device comprising processing circuitry configured to perform the steps of the method of claim 1.

18. A non-transitory computer-readable medium comprising computer executable instructions executable by processing circuitry, which, when executed, cause the processing circuitry to perform the steps of the method of claim 1.
